(19) United States
(12) Patent Application Publication
(10) Pub. No.: US 2024/0375885 A1
(43) Pub. Date: Nov. 14, 2024

(54) Handling Installation, Food Processing Installation, and Method for Handling Food Items

(71) Applicant: VALKA EHF., Kopavogur (IS)

(72) Inventors: Hilmar ERLINGSSON, Kopavogur (IS); Sverrir HARALDSSON, Kopavogur (IS); Saulius GENUTIS, Egilsstadir (IS); Ulfar Karl ARNORSSON, Kopavogur (IS); Helgi HJALMARSSON, Kopavogur (IS)

(21) Appl. No.: 18/683,564

(22) PCT Filed: Aug. 18, 2022
(86) PCT No.: PCT/EP2022/073081

§ 371 Date: Feb. 14, 2024

(30) Foreign Application Priority Data
Aug. 20, 2021 (EP) 21192376.8

(51) Int. Cl. B65G 47/28; A22C 25/08; B65G 43/08; B65G 47/76

(52) U.S. Cl. CPC B65G 47/28; A22C 25/08; B65G 43/08; B65G 47/766; B65G 2201/0202; B65G 2203/0225; B65G 2203/0233; B65G 2203/044

(57) ABSTRACT

A handling installation for handling food items, includes a conveying device, and at least one separating device downstream from the conveying device. The separating device has at least one conveying space through which the food items can be conveyed and at least one deflecting device positionable to at least partially protrude into the conveying space to deflect at least one first food item at least partially away from at least one second food item in order to increase the spacing between at least the first food item and the second food item to separate a food cluster. Alternatively, a rotating device for rotating and changing an orientation of the food item may be provided. Methods for handling food items and a food processing installation may include the handling installation.

Food items, in particular agricultural products, such as meat, poultry, fish, and plant-based products, are commonly processed in one or more processing steps at one or more processing stations before being offered to consumers. The food items are typically handled by various handling devices prior to, during and/or after each processing step, or at least some of the processing steps.

Since processing and handling food items manually is labor- and/or time-intensive, the processing and/or handling of food items has largely been automated in order to increase efficiency and reduce costs.

Such automated processing and handling of food items may include receiving and sorting the whole food items, such as whole fish. Further steps may include gutting, de-heading, filleting and skinning the food items, e.g., the fish, in various processing and handling steps.

The food items may be handled prior to, i.e., upstream from, a respective processing station, during processing at a respective processing station, and/or after, i.e., downstream from, a respective processing station.

Since handling food items is largely dependent on automation, as described above, providing a reliable, flexible, effective and/or efficient handling of the food items is essential to provide a throughput of food items through the processing stations which substantially matches, or at least does not severely lag behind, the capacity of the respective processing plant.

Inefficient and/or deficient handling of the food items may lead to a reduction in the throughput of food items in the respective processing plant which may increase the costs and/or reduce the turnover and/or the business volume of the respective processing plant.

For instance, the processing of food items may be improved by handling the respective food items in a specific manner in preparation for the respective processing step such that the processing step may be performed more quickly and/or efficiently after the food items have been prepared in one or more handling steps accordingly.

For instance, EP 3 639 670 A1 discloses a method of flipping a whole fish by using guiding rollers and a guiding channel to turn the whole fish as it is being conveyed. The guiding rollers are each formed by two truncated cones which together form a section having a reduced cross-section in order to position the whole fish as it is being conveyed underneath the rollers. Thus, the effectiveness and/or efficiency of such a handling step is dependent, inter alia, on the size of the whole fish since the force effected by the guiding rollers onto the whole fish may vary depending on the size of the whole fish. Moreover, such a handling device may only be effective for a certain size range of whole fish. Larger whole fish may not fit underneath the guiding rollers and/or in the guiding channel and smaller whole fish may not be effectively positioned by the guiding rollers. This limits the size range of the whole fish which may be handled by the disclosed device.

Moreover, EP 2 373 174 B1 discloses a vibrating conveying device to transport fish in a desired direction with a certain orientation. The vibrating surface has a specific surface finish to facilitate sliding the fish in a certain direction. However, the effectiveness of such a conveying device is also dependent on the size of the fish since larger, and thus heavier, fish react differently to the vibrations effected on the fish than smaller, and thus lighter, fish. In particular, the mechanism is not capable of processing larger fish species.

Thus, the prior art has not or at least not sufficiently addressed the matters described above.

Thus, it is an object of the present invention to provide a flexible, effective and/or efficient handling means for handling food items.

This object is achieved by a handling installation for handling food items defined by the features of claim 1.

Preferred variations and further developments are defined by the features of the dependent claims.

The handling installation includes at least one conveying device having at least one support surface configured to support a plurality of food items. The conveying device is driven by at least one driving device to move the support surface along a conveying direction to convey the food items in the conveying direction.

Preferably, the food items are whole fish. The term “whole fish”, within the context of the present disclosure, is to be understood as a fish which has not, or only minimally, been processed by removing one or more portions of the fish. Preferably, the whole fish has only been processed by one of more of the following: bleeding out, at least partially gutting, and removing the head and/or the tail of the fish. A “whole fish” preferably excludes filleted fish. Thus, the “whole fish”, for instance, may include fishbones and skin.

The handling installation described herein may be used to handle a wide variety of different food items, such as agricultural products. For instance, the handling installation described herein may handle food items such as meat, poultry, fish, and/or plant-based products.

The support surface may be substantially planar at least in a section thereof. The support surface may include slip-reducing features which may prevent, or at least reduce, slipping of the food items on the support surface as the food items are being conveyed in the conveying direction. For instance, the support surface may be formed irregularly in at least some sections thereof. For instance, the support surface may have textured and/or roughened sections and/or protrusions extending from the support surface. Alternatively, or additionally, the support surface may have grooves formed therein to reduce slipping. Such slip-reducing features may increase friction between the support surface and the food items as the food items are being conveyed in the conveying direction.

The conveying device may include a conveying element, such as a belt, preferably an endless belt, which at least partially defines the support surface. The conveying element may have a substantially continuous surface to provide a continuous support surface for the food items to lie on. The conveying element may be substantially flexible. Moreover, the conveying element may be permeable to water and/or gas. This may enable liquid, such as water, which may adhere to or be transported with the food items, for instance a fish, to be removed, dried and/or drained from the support surface.

Alternative conveying elements, i.e., besides a belt, may also be used, such as a plurality of movable plates or a fabric, such as a plain-woven fabric. The conveying element may be made of a material which is suited for the respective application. For instance, the conveying element may be made of a material which is bacteriostatic or at least includes at least one bacteriostatic agent.

The driving device may be any device capable of converting energy into motion to drive the conveying device into motion. For instance, the driving device may be an electric motor, a pneumatic drive, a piezo drive, etc.

The driving device may be configured to engage with a section of the conveying element to drive the conveying element in the conveying direction. The engagement between the driving device and the conveying element, in order to transfer a driving force from the driving device to the conveying element, may be based on friction and/or a form fit.

The handling installation may include a plurality of driving devices, each driving device being configured to engage with a section of the conveying element to drive the conveying element in the conveying direction.

The handling installation preferably includes a controller having a processing circuitry for automatically providing commands to components of the handling installation and/or for processing and forwarding manual commands entered, e.g., via a command receiving interface provided by the handling installation, by a user. The controller may be integrated in a central processing unit of the handling installation.

The conveying device may be configured to have a variable and/or adjustable speed. The speed of the conveying device is preferably a translational speed of the support surface. Preferably, the speed of the conveying device may be adjusted by varying a speed, preferably a rotational speed, of at least one driving element of the driving device(s). For instance, a controller, such as the controller described above, may be configured to automatically and/or manually control the speed of the conveying device or driving device(s), respectively. This may allow the speed of the conveying device or driving device(s), respectively, to be controlled. Controlling the speed of the conveying device or driving device(s), respectively, may be based on the available capacity of the processing plant and/or at least one processing station which is arranged upstream from the conveying device and/or downstream from the conveying device, with respect to the conveying direction. Thus, for instance, if the throughput of the food items along the conveying device surpasses the respective capacity, the speed of the conveying device or driving device(s), respectively, may be decreased and/or if the throughput of the food items lags behind the respective capacity, the speed of the conveying device or driving device(s), respectively, may be increased.

To automatically control the speed of the conveying device or driving device(s), respectively, the handling installation may include at least one detecting element, preferably an optical detecting element, such as a camera, configured to detect the throughput of the food items along the conveying device and provide information regarding the detected throughput, e.g., to a controller, preferably having or at least being associated with a processing circuitry to process the received information. The controller and/or the processing circuitry may be configured to compare the detected throughput with a target throughput or target range of throughput and adjust the speed of the driving device(s) or maintain the set speed of the driving device(s) if the detected throughput substantially matches the target throughput or is within a target range of throughput. The conveying device may be configured with a start-stop function as a speed control to stop and start the conveying device or driving device(s), respectively, on demand.

The handling installation may include a plurality of conveying devices. At least two conveying devices may be arranged parallel to each other and/or in series.

The dimensions of the conveying devices may be substantially the same. Alternatively, the dimensions of at least two conveying devices may be substantially different. For instance, two conveying devices may be arranged in series, a first conveying device arranged upstream from a second conveying device. The second conveying device, i.e., the downstream conveying device, may have a greater width than the first conveying device. This may be advantageous to ensure that the food items are arranged in a single layer on the second conveying device to facilitate handling and/or processing of the food items.

The speeds of conveying devices may also be controlled synchronously or independently. Preferably, two conveying devices may be arranged in series, a first conveying device being arranged upstream from a second conveying device. A speed of the second conveying device, i.e., the downstream conveying device, may be adjustable to be greater than a speed of the first conveying device. This may also be advantageous to ensure that the food items are arranged in a single layer on the second conveying device to facilitate handling and/or processing of the food items.

The handling installation further includes at least one separating device arranged downstream from the conveying device, with respect to the conveying direction. The separating device is configured to at least partially separate clusters of food items which are conveyed on the support surface. The above-described control of the speeds of the conveyor device(s) may be configured as an in-feed control of the amount of food items which are fed to the separating device.

Food items to be processed and/or handled in a processing plant typically arrive in bulk at the processing plant. Thus, the food items may arrive in clusters, in which the food items are arranged in close vicinity to each other and/or in which the food items are at least partially touching each other and/or in which the food items are at least partially overlapping. However, providing sufficient access to each individual food item for a respective handling and/or processing device may facilitate the processing of each individual food item to increase the effectiveness and/or efficiency of the processing and/or handling.

For instance, when transporting fish into a processing plant, the fish are commonly put in tubs in fishing vessels. For harvested fish, live fish are usually pumped directly from well boats or from cages outside of the processing plants into the processing plants. The fish may be first transported to a fish slaughtering equipment and then fed through bleeding equipment. Bleeding commonly takes place in compartments or slots provided in bleeding tanks in which there is no control of individual fish. Hence, multiple fish may be in the same compartment or slot. When the fish exit the bleeding tank, they are transported in bulk to processing and/or handling stations, which may lead to clusters of fish being conveyed together.

Thus, the present disclosure provides a separating device which is configured to at least partially separate clusters of food items which are conveyed on the support surface in order to facilitate individual access to each food item.

Moreover, the advantageous effects described above may be provided for a wide range of sizes and weights of food items, e.g., fish. Thus, the flexibility and range of possible applications of the handling installation described herein may be greater than is the case for the installations described in the prior art.

In addition, the separating device, more specifically the deflecting device, may be deployed on demand, which increases the flexibility of the handling installation. For instance, for some food items, the separating device, more specifically the deflecting device, may not be deployed if not desired and/or required.

The separating device has at least one conveying space through which the food items can be conveyed, preferably by means of a gravitational force, and at least one deflecting device. The at least one deflecting device is positionable to at least partially protrude into the conveying space to deflect at least one first food item at least partially away from at least one second food item in order to increase the spacing between at least the first food item and the second food item to separate a food cluster. Preferably, the deflecting device is configured to deflect the at least one first food item at least partially away from the at least one second food item in a non-invasive manner, i.e., without puncturing an outer surface of the respective food item(s).

Due to the increased spacing between the first food item and the second food item which may be effected by the deflecting device, accessing each of the first food item and the second food item individually in subsequent handling and/or processing steps may be facilitated as a result. For instance, the deflecting device may be configured to effect a force on the first food item and/or the second item such that the shortest distance between the first food item and the second food item is increased. As detailed above, the food items may be touching each other and/or overlapping in said clusters. Hence, the deflecting device may be configured to effect a force on the touching and/or overlapping food items such that the food items are at least no longer touching each other after the deflecting device has effected a force on the respective food items. For instance, the first food item and/or the second item may be deflected in different directions, e.g., opposite directions, by the deflecting device.

Preferably, the deflecting device is positionable to at least partially protrude into the conveying space to deflect at least one first food item at least partially away from at least one second food item by displacing the deflecting device along at least one degree of freedom, preferably at least up-and-down, i.e., along the direction of gravity. Preferably, the deflecting device is configured to be displaced only along one degree of freedom, preferably only up-and-down, to position the deflecting device to at least partially protrude into the conveying space to deflect at least one first food item and retract the deflecting device, e.g., when a deflection is not desired. This may simplify the positioning mechanism of the deflecting device, compared with a positioning mechanism which has more degrees of freedom.

The deflecting device may be stationary as the deflecting device deflects at least one first food item at least partially away from at least one second food item. Alternatively, the deflecting device may be moved for at least a portion of the duration during which the deflecting device deflects the first food item at least partially away from the second food item. By moving the deflecting device a force which is effected on the first food item and/or the second item may be increased, e.g., to increase the spacing between at least the first food item and the second food item to increase the separation of the food cluster.

The separating device may be configured to provide a plurality of lanes, in each of which food items may be conveyed, preferably in a single file, i.e., one behind the other. For instance, the separating device may be configured to provide at least 2 or more, preferably at least 3, lanes, in each of which food items may be conveyed, preferably in a single file, i.e., one behind the other. This may provide a single row of food items, i.e., fish, in each lane, wherein the food items are preferably spaced apart from each other in the conveying direction, preferably by a desirable and/or predetermined distance. This may be referred to in the field as “singulation”. The food items in two or more of the lanes may be merged to one or more consolidated rows of food items, preferably at one or more merging stations arranged downstream from the handling installation. For instance, three lanes of food items may be merged to two rows or a single row of food items at one or more merging stations arranged downstream from the handling installation.

Preferably, the food items are spaced apart from each other, in the conveying direction, by a regular distance in each lane and/or each row. Alternatively, or additionally, the distance between adjacent food items, in the conveying direction, is within a desirable and/or predetermined range. In particular, the food items may be processed at one or more processing stations arranged downstream from the handling installation. For instance, at least some of the food items may be separated, e.g., cut, into a plurality of smaller portions. Hence, providing a single row of food items, i.e., fish, in each lane and/or row, wherein the food items are preferably spaced apart from each other in the conveying direction, preferably by a desirable and/or predetermined distance, may facilitate processing the food items at one or more downstream processing stations, e.g., by facilitating access to each food item by one or more processing devices, e.g., one or more cutting/separating devices and/or one or more handling devices, e.g., gripping devices, such as gripping robots.

One or more gripping devices, such as one or more gripping robots, may be provided downstream and/or upstream from the separating device. The one or more gripping devices, such as one or more gripping robots, may be included in the handling installation described herein. Alternatively, the one or more gripping devices may be separate devices. The one or more gripping devices may be configured and arranged to grip, and optionally sort, the whole food items, e.g., whole fish, and/or smaller portions of the food items, e.g., after the whole food items have been separated, e.g., cut, into the smaller portions, at one or more locations downstream and/or upstream from the handling installation described herein.

The one or more gripping devices, such as one or more gripping robots, may include one or more engaging devices configured to engage each food item, preferably individually, to move, e.g., sort, the respective food item, preferably by at least partially, preferably completely, lifting the respective food item. Preferably, the one or more engaging devices may be configured to engage and move, e.g., sort, preferably by at least partially, preferably completely, lifting, the respective food item(s) in a non-invasive manner, i.e., without puncturing an outer surface of the respective food item(s).

Each lane may be at least partially delimited by at least a section of the deflecting device or by at least a section of a plurality of deflecting devices. This may facilitate the processing of the food items at one or more processing stations arranged downstream from the separating device. For this purpose, each deflecting device may extend in the conveying direction of the food items by a distance of at least 8 cm, preferably at least 10 cm, more preferably at least 12 cm, more preferably at least 14 cm, more preferably at least 16 cm, more preferably at least 18 cm, more preferably at least 20 cm.

The deflecting device may be configured to deflect one or more food items towards a certain lane, e.g., a desired lane for the one or more food items to travel, e.g., to be conveyed, in. For instance, one or more food items may be arranged on the conveying device such that the one or more first food items would be destined to travel through a first lane, if they are not deflected, or deflected only minimally, by the deflecting device. However, the deflecting device may be configured to deflect the one or more food item in a direction such that the one or more first food items travel through a second lane which is different than the first lane, rather than through the first lane.

The deflecting device may be movable between a plurality of different positions. For instance, the deflecting device may be movable between at least a non-protruding position, in which the deflecting device does not substantially protrude into the conveying space, and a protruding position, in which the deflecting device protrudes into the conveying space. In order to provide such movability of the deflecting device, an actuating device may be provided which may actuate the movement of the deflecting device.

The deflecting device may be configured to be orientated relative to the conveying direction of the food items along the conveying device such that a longitudinal axis of the deflecting device is angled relative to the conveying direction by a non-zero angle, preferably by an angle of at least 10°, more preferably at least 15°, more preferably at least 20°, more preferably at least 25°, more preferably at least 30°, more preferably at least 35°, more preferably at least 40°, more preferably at least 45°. This may allow the deflecting device to deflect one or more food items based at least on the orientation of the deflecting device relative to the conveying direction of the food items, e.g., entirely passively. In other words, the deflecting device may be configured to remain stationary, i.e., without moving, as the respective food item is being deflected by the deflecting device. Preferably, the longitudinal axis of the deflecting device extends along, i.e., parallel to, a floor of the conveying space.

The deflecting device may have a length and a height, wherein the deflecting device has a length-to-height ratio of at least 1.5, preferably at least 2, more preferably at least 2.5, more preferably at least 3. The length of the deflecting device is preferably the greatest dimension of the deflecting device and preferably extends along a floor of the at least one conveying space. The height of the deflecting device preferably extends substantially perpendicularly to the floor of the at least one conveying space.

The deflecting device may also be movable between a plurality of orientations in the conveying space. For instance, an angle of the deflecting device, e.g., relative to the conveying direction of the food items, may be adjustable. This may increase the flexibility of the deflecting device and may allow the deflecting device to adapt to different conditions, such as different positions and/or formations of clusters.

The deflecting device may be moved manually and/or automatically. For this purpose, the handling installation may include a controller configured to automatically and/or manually control the movement of the deflecting device.

For the purpose of manually moving the deflecting device, the controller may be configured to receive commands from a user for controlling the movement of the deflecting device. The handling installation may include a command receiving interface configured to enable the user to input commands for controlling the movement of the deflecting device into the command receiving interface which are provided to the controller.

For the purpose of automatically moving the deflecting device, the handling installation may include at least one detecting element configured to detect a cluster of food items on the support surface and/or in the conveying space and provide information regarding the detected cluster of food items, e.g., to a controller. The information may include at least one of the following: an angle between an axis, preferably a longitudinal axis, of the food item and the conveying direction of the food item, a length of the food item along the conveying direction of the food item, a distance of the food item to a border of the conveying device(s) and/or the separating device(s), an orientation of the food item relative to the conveying direction and an orientation of a pre-determined feature of the food item in at least a section of the food item relative to the conveying direction of the food item and/or to a predetermined side of the conveying device.

The controller may be configured to initiate movement of the deflecting device based on the information provided by the detecting element. The movement may include moving the deflecting device between different extents of protrusion into the conveying space. For instance, the deflecting device may be moved from a non-protruding position, in which the deflecting device does not substantially protrude into the conveying space, to a protruding position, in which the deflecting device protrudes into the conveying space. Alternatively, or additionally, the deflecting device may be moved from at least a first protruding position, in which the deflecting device protrudes into the conveying space at a first positive extent of protrusion, to a second protruding position, in which the deflecting device protrudes into the conveying space at a second positive extent of protrusion, the second extent of protrusion being greater than the first extent of protrusion.

Alternatively, or additionally, the movement may include moving the deflecting device between a plurality of orientations in the conveying space. For instance, an angle of the deflecting device, e.g., relative to the conveying direction of the food items, may be adjustable.

The deflecting device may be a, preferably planar, plate-like element. The deflecting device may have at least two side surfaces, which are preferably parallel. The side surfaces may provide a resistance force against a food item to deflect the food item away from its initial path and away from another food item. The deflecting device may have a shape which is suited and/or adapted to the specific application. For example, the deflecting device may be rectangular, triangular, polygonal, etc., when viewed from the side surface of the deflecting device.

The conveying space may be delimited at least by a floor, which may provide a support surface for the food items as the food items are being conveyed through the conveying space, and at least two side walls, which may at least partially delimit the conveying space laterally. Optionally, the conveying space may be at least partially delimited by a lid.

The food items may be conveyed through the conveying space passively, e.g., by gravitational forces. For this purpose, the support surface may be angled downwards or diagonally downwards relative to a horizontal plane which extends substantially perpendicularly to the force of gravity.

Alternatively, or additionally, the food items may be conveyed through the conveying space actively by at least one driving means, e.g., by an electric motor, a pneumatic drive, a piezo drive, or other driving devices.

For this purpose, a floor which at least partially delimits the conveying space may be movable, such as by being driven by said driving means. Thus, the food items can be conveyed through the conveying space by moving the floor of the conveying space.

Preferably, the separating device has a floor which at least partially delimits the conveying space and along which the food items may be conveyed through the conveying space. The deflecting device may be positionable to protrude through at least a portion of the floor and into the conveying space. By configuring the deflecting device to protrude through at least a portion of the floor and into the conveying space, the deflecting device may be deployed into the conveying space in a simple and quick manner. For instance, the deflecting device may be arranged in a non-deployed position beneath a location of the floor at which food item clusters often or at least repeatedly occur. Thus, to separate the food item clusters, the deflecting device may be deployed through the floor to a deployed position. Further adjusting of the deflecting device, such as adjusting the orientation of the deflecting device, may not necessarily be required to effect a separation of the food items cluster since the deflecting device is already arranged in a location of the floor at which food item clusters often or at least repeatedly occur after being deployed through the floor. Moreover, this may enhance a stowability of the deflecting device when the deflecting device is not required and/or desired, e.g., by retracting the deflecting device through the floor and thus out of the conveying space. This may reduce the intrusiveness of the deflecting device when the deflecting device is not required and/or desired. The floor may be provided with one opening, such as a slot, or a plurality of openings, through which the deflecting device may protrude and/or be deployed into the conveying space.

Preferably, the deflecting device, when the deflecting device is positioned to protrude at least partially into the conveying space, partitions at least a section of the conveying space into two or more conveying space channels through which the food items can be separately conveyed.

The conveying space channels may provide two at least partially separate sections of the conveying space through which individual food items may be transported. This may provide a more effective and efficient separate of food items from each other to improve the dissolution of clusters.

Preferably, the floor is declined, in the conveying direction of the conveying device, relative to a horizontal plane, when the handling installation is in an operating position, and/or relative to the support surface of the conveying device. A horizontal plane is to be understood as being a plane which extends perpendicularly to the direction of gravitational forces. By providing a declined floor the food items may slide down the floor in a chute-like manner as gravitational forces act on the food items. The gravitational forces which cause the food items to slide and/or accelerate down the floor may increase the force which is effected against the food items by the deflecting device. This may provide a more effective and efficient separation of food items from each other in order to improve the dissolution of clusters of food items.

Preferably, the deflecting device is movable between a non-deflecting position, in which the deflecting device is retracted from the conveying space, and a deflecting position, in which the deflecting device protrudes at least partially into the conveying space to deflect the at least one first food item at least partially away from the at least one second food item in order to increase the spacing between at least the first food item and the second food item to separate a food cluster. By configuring the deflecting device to be movable between said non-deflecting position and said deflecting position, an effective deflection of the food items may be provided while the deflecting device is in the deflecting position, whereas the deflecting device may be stowed away in the non-deflecting position when deflection of food items by the deflecting device is not required and/or desired. This may reduce the intrusiveness of the deflecting device when the deflecting device is not required and/or desired.

Preferably, the handling installation further includes at least one actuating device operatively coupled with at least the deflecting device. Optionally, the handling installation may also include a controller operatively coupled with the actuating device. The actuating device may be configured to move the deflecting device between the non-deflecting position and the deflecting position on demand, preferably automatically based on at least one command which the controller is configured to provide. This may increase the user-friendliness and/or the degree of automation of the handling installation. The actuating device may reduce the duration required to deploy the deflecting device to the deflecting position and/or retract the deflecting device to the non-deflecting position. The actuating device may be configured to move the deflecting device between the non-deflecting position and the deflecting position when a deflection of food items is required and/or desired. The actuating device may be actuated manually by a user, e.g., via commands which may be entered by a user in a command receiving interface provided by the handling installation. The handling installation may include a plurality of deflecting devices and a plurality of actuating devices, wherein preferably each deflecting device is individually associated with its own actuating device.

Alternatively, or additionally, the actuating device may be actuated automatically. For the purpose of automatically actuating the actuating device to move the deflecting device, the handling installation may include at least one detecting element configured to detect information related to a location and/or an orientation of each food item being conveyed on the support surface. The information may be related to a formation of clusters of food items such that the information may indicate a potential cluster of food items. The detecting element may provide the detected information to a controller. The information may include at least one of the following: an angle between an axis, preferably a longitudinal axis, of the food item and a conveying direction of the food item, a length of the food item along the conveying direction of the food item, a distance of the food item to a border of the conveying device(s) and/or the separating device(s), an orientation of the food item relative to the conveying direction and an orientation of a pre-determined feature of the food item in at least a section of the food item relative to the conveying direction of the food item and/or to a predetermined side of the conveying device. Based at least partially on the information, the controller, or a processing circuitry included in the controller or at least associated with the controller, may determine whether a cluster of food items is present. If it is determined that a cluster of food items is present, the actuating device may be actuated automatically to deploy the deflecting device to the deflecting position.

Thus, the controller may be configured to initiate movement of the deflecting device via the actuating device based at least partially on the information provided by the detecting element. The movement may include moving the deflecting device between different extents of protrusion into the conveying space. For instance, the deflecting device may be moved from a non-protruding position, in which the deflecting device does not substantially protrude into the conveying space, to a protruding position, in which the deflecting device protrudes into the conveying space. Alternatively, or additionally, the movement may include moving the deflecting device between a plurality of orientations in the conveying space. For instance, an angle of the deflecting device, e.g., relative to the conveying direction of the food items, may be adjustable.

The deflecting device may be operable in both a manual and an automatic mode, in parallel or in series. For instance, the deflecting device may be operable in an automatic mode but which may be overridden by a manual control, e.g., by a user.

Preferably, when the deflecting device is positioned to protrude at least partially into the conveying space, the deflecting device protrudes into the conveying space by a first distance at a first position and by a second distance at a second position, the second position being downstream from the first position with respect to a conveying direction of the food items, wherein the second distance is greater than the first distance. Thus, the extent at which the deflecting device protrudes into the conveying space may increase in a downstream direction. This may allow a separation of at least two food items from each other to be performed more reliably, efficiently and effectively than if the deflecting device would protrude into the conveying space to the same extent along a downstream direction. Moreover, such a configuration may prevent food items from collecting at a leading upstream section of the deflecting device, e.g., at a first point of contact of the food items with the deflecting device as the food items are being conveyed, and jamming the flow of food items.

Configuring the second distance to be greater than the first distance may be achieved by the shape and/or dimensions of the deflecting device itself. For instance, the deflecting device may have a first height and a second height extending in the protruding direction, the first height being at the first position and the second height being at the second position, the second height being greater than the first height. Alternatively, or additionally, configuring the second distance to be greater than the first distance may be achieved by other means, such as by moving the deflecting device at different sections thereof to different extents into the conveying space. For instance, a first section of the deflecting device, the first section being arranged at the first position, may be moved into the conveying space to a greater extent than a second section of the deflecting device, the second section being arranged at the second position.

The first distance and/or second distance may be adjustable to allow adjustment of the extent of protrusion of the deflecting device into the conveying space as desired and/or required. For instance, at least one section, preferably a plurality of different sections, of the deflecting device may be movable into the conveying space to an extent which is adjustable.

Preferably, the deflecting device is an elongated body, preferably a substantially planar and elongated body, having a longitudinal axis which is angled relative to a vertical plane which extends in or along the conveying direction of the conveying device and/or relative to a longitudinal median plane of the conveying device and/or a longitudinal median plane of the conveying device in which a longitudinal axis of the conveying device, which preferably extends along the conveying direction of the conveying device, lies, when the handling installation is in an operating position. A vertical plane is to be understood as a plane which extends substantially in the direction of the force of gravity. By configuring the deflecting device to have such an orientation relative to said vertical plane and/or longitudinal median plane of the conveying device, a relatively large portion of the side surfaces of the deflecting device is exposed to the oncoming food items, when the deflecting device is in a deployed position. This may increase the degree and reliability of the separation of food items.

Preferably, the separating device includes a plurality of deflecting devices. At least two of the deflecting devices may be positionable and/or actuatable independently from one another to at least partially protrude into the conveying space simultaneously or non-simultaneously. This may increase the degree of dissolution of clusters of food items and/or may allow a plurality of clusters of food items to be dissolved simultaneously.

The deflecting devices may extend substantially parallel to each other, preferably substantially along a longitudinal axis of the conveying space

Preferably, the handling installation includes at least two conveying devices arranged in series, in a conveying direction of the food items. Each conveying device may have at least one support surface configured to support a plurality of food items and each conveying device being driven by at least one driving device to move the support surface along a conveying direction to convey the food items in the conveying direction, respectively. A first conveying device of the at least two conveying devices may be operable at a first conveying speed and a second conveying device of the at least two conveying devices, which is downstream from the first conveying device with respect to the conveying direction of the food items, may be simultaneously operable at a second conveying speed. The first conveying speed and the second conveying speed may be adjustable to differ from each other. Preferably, the first conveying speed is lower than the second conveying speed. This may be advantageous to ensure that the food items are arranged in a single layer on the second conveying device to facilitate handling and/or processing of the food items.

Preferably, the downstream conveying device of the two conveying devices is wider than the upstream conveying device and the second conveying speed is faster than the first conveying speed. This may be advantageous to ensure that the food items are arranged in a single layer on the downstream conveying device to facilitate handling and/or processing of the food items.

Preferably, the handling installation includes a plurality of separating devices arranged in series, with respect to a conveying direction of the food items. Each separating device may have at least one conveying space through which the food items can be conveyed in a respective conveying direction and at least one deflecting device.

Preferably, a longitudinal axis of at least one deflecting device of a first separating device of the plurality of separating devices is angled by a first separating device angle relative to a vertical plane which extends in or along the conveying direction of the conveying device and/or relative to a longitudinal median plane of the conveying device and/or relative to a longitudinal median plane of the conveying device in which a longitudinal axis of the conveying device, which preferably extends along the conveying direction of the conveying device, lies, when the handling installation is in an operating position; and a longitudinal axis of at least one deflecting device of a second separating device of the plurality of separating devices is angled by a second separating device angle relative to the vertical plane which extends in or along the conveying direction of the conveying device and/or relative to the longitudinal median plane of the conveying device and/or relative to the longitudinal median plane of the conveying device in which a longitudinal axis of the conveying device, which preferably extends along the conveying direction of the conveying device, lies, when the handling installation is in an operating position, the second separating device angle being different than the first separating device angle. Providing two separating devices which are angle differently may enable to more effectively, flexible and reliably dissolve clusters of food items. In particular, this may allow the separating devices to provide a reliable and effective dissolution of clusters for a wide range of different locations of clusters on the support surface and/or for different cluster formations and/or different cluster sizes.

Preferably, each conveying space of the separating device extends along a respective centerline along which the food items can be conveyed.

Preferably, the centerline of the conveying space of a first separating device of the plurality of separating devices is angled by a first conveying space angle relative to the vertical plane and/or the longitudinal median plane of the conveying device and/or the longitudinal median plane of the conveying device in which a longitudinal axis of the conveying device, which preferably extends along the conveying direction of the conveying device, lies, when the handling installation is in an operating position,; and the centerline of the conveying space of a second separating device of the plurality of separating devices is angled by a second conveying space angle relative to the vertical plane and/or the longitudinal median plane of the conveying device and/or the longitudinal median plane of the conveying device in which a longitudinal axis of the conveying device, which preferably extends along the conveying direction of the conveying device, lies, when the handling installation is in an operating position, the second conveying space angle being different than the first conveying space angle. Providing two separating conveying spaces with different conveying space angles, the conveying spaces arranged in series, may enable to more effectively, flexible and reliably dissolve clusters of food items. In particular, the food items may be redirected in different directions in each of the conveying spaces due to the varying conveying space angles. Since the food items are fed through each conveying space, the food items are subjected to differently configured conveying spaces. This may allow the food items to strike the respective deflecting device at different angles and/or at different sections of the respective deflecting device during separation of the clusters. This may provide a reliable and effective dissolution of clusters for a wide range of different locations of clusters on the support surface and/or for different cluster formations and/or different cluster sizes.

Preferably, the longitudinal axis of at least one deflecting device of the first separating device and the longitudinal axis of at least one deflecting device of the second separating device are angled towards opposite sides of the vertical plane and/or the longitudinal median plane of the conveying device and/or the longitudinal median plane of the conveying device in which a longitudinal axis of the conveying device, which preferably extends along the conveying direction of the conveying device, lies, when the handling installation is in an operating position;
and/or
   the centerline of the conveying space of the first separating device and the centerline of the conveying space of the second separating device are angled towards opposite sides of the vertical plane and/or the longitudinal median plane of the conveying device and/or the longitudinal median plane of the conveying device in which a longitudinal axis of the conveying device, which preferably extends along the conveying direction of the conveying device, lies, when the handling installation is in an operating position. This may increase the separate effect to more effectively and efficiently dissolved clusters of food items. For instance, a first cluster of food items may be arranged at or near a first side wall of the conveying device and a second cluster of food items may be arranged at or near a second side wall of the conveying device which is arranged substantially opposite from the first side wall. A conveying device space having a centreline which is angled towards one side of the vertical plane and/or the longitudinal median plane of the conveying device may be particularly effective at separating clusters which are arranged at the first side wall. However, the same conveying device space may not be as effective at separating clusters which are arranged at the second side wall. By arranging two conveying spaces having centerlines which are angled towards opposite sides, dissolution of clusters for a wide range of different cluster locations and/or cluster shapes may be reliably and efficiently provided.

One longitudinal axis/centerline may be angled to the right side of the plane and other longitudinal axis/centerline may be angled to the left side of the plane.

The handling installation may include at least two conveying devices arranged in series, with respect to a conveying direction of the food items. Each conveying device may have at least one support surface configured to support a plurality of food items and each conveying device being driven by at least one driving device to move the support surface along a conveying direction to convey the food items in the conveying direction, respectively. Each separating device of the plurality of separating devices may be arranged downstream from and adjacent to a respective one of the conveying devices such that the food items are fed directly from the respective conveying device to the respective separating device.

Preferably, the handling installation further includes at least one detection device, preferably an optical detection device, configured to detect each food item on the conveying device(s) and/or the separating device(s) and provide information related to a location and/or an orientation of each food item, wherein at least one deflecting device is positionable and/or a conveying speed of at least one conveying device and/or conveying speeds of a plurality of conveying devices is/are adjustable, preferably by means of a controller and optionally at least one actuator communicatively coupled to the controller, based at least partially on the information provided by the detection device, preferably the controller and the actuator being configured to perform the positioning and/or adjusting automatically. Basing the positioning of the deflecting device and/or the conveying speed(s) of the conveying device(s) and/or conveying speeds of a plurality of conveying devices is/are at least partially on the information provided by the detection device may enable a higher level of automation which may increase the user-friendliness and reliability of the handling installation. This may reduce costs for operating the handling installation.

Preferably, the handling installation includes a plurality of detection devices, preferably optical detection devices, each being associated with one of the conveying devices and with the respective separating device arranged downstream from and adjacent to the respective conveying device, the detection devices being configured to detect each food item on the respective conveying device and/or the respective separating device and provide information related to a location and/or an orientation of each food item, wherein each deflecting device is positionable and/or a conveying speed of the conveying device and/or conveying speeds of a plurality of conveying devices is/are adjustable, preferably by means of a controller and optionally at least one actuator communicatively coupled to the controller, based at least partially on the information provided by the associated detection device, preferably the controller and the actuator being configured to perform the positioning and/or adjusting automatically. This may further increase the level of automation, user-friendliness and reliability of the handling installation.

Preferably, the information provided by the detection device includes at least one of the following: an angle between an axis, preferably a longitudinal axis, of the food item and a conveying direction of the food item, a length of the food item along the conveying direction of the food item, a distance of the food item to a border of the conveying device(s) and/or the separating device(s), an orientation of the food item relative to the conveying direction and an orientation of a pre-determined feature of the food item in at least a section of the food item relative to the conveying direction of the food item and/or to a predetermined side of the conveying device.

The object of the invention identified at the beginning is also achieved by a method for handling food items defined by the features of the independent method claim 15.

The effects, advantages and various embodiments described above in conjunction with the handling installation also apply to the method accordingly.

The method includes the following steps:
conveying a plurality of food items on at least one support surface of at least one conveying device, the conveying device being driven by at least one driving device to move the support surface along a conveying direction to convey the food items in the conveying direction;
   feeding the plurality of food items from the support surface of the conveying device to a conveying space of a separating device arranged downstream from the conveying device, with respect to the conveying direction, the food items being conveyed through the conveying space;
   at least partially separating clusters of food items which are conveyed on the support surface and/or in the conveying space by positioning at least one deflecting device of the separating device to at least partially protrude into the conveying space to deflect at least one first food item at least partially away from at least one second food item in order to increase the spacing between at least the first food item and the second food item.

The object of the invention identified at the beginning is also achieved by a handling installation for handling food items according to a second aspect of the invention.

The support surface may be substantially planar at least in a section thereof. The support surface may include slip-reducing features which may prevent, or at least reduce, slipping of the food items on the support surface as the food items are being conveyed in the conveying direction. For instance, the support surface may be formed irregularly in at least some sections thereof. For instance, the support surface may have textured and/or roughened sections and/or protrusions extending from the support surface. Alternatively, or additionally, the support surface may have grooves formed therein to reduce slipping. Such slip-reducing features may increase friction between the support surface and the food items as the food items are being conveyed in the conveying direction.

The conveying device may include a conveying element, such as a belt, preferably an endless belt, which at least partially defines the support surface. The conveying element may have a substantially continuous surface to provide a continuous support surface for the food items to lie on. The conveying element may be substantially flexible. Moreover, the conveying element may be permeable to water and/or gas. This may enable liquid, such as water, which may adhere to or be transported with the food items, for instance a fish, to be removed, dried and/or drained from the support surface.

Alternative conveying elements, i.e., besides a belt, may also be used, such as a plurality of movable plates or a fabric, such as a plain-woven fabric. The conveying element may be made of a material which is suited for the respective application. For instance, the conveying element may be made of a material which is bacteriostatic or at least includes at least one bacteriostatic agent.

The driving device may be any device capable of converting energy into motion to drive the conveying device into motion. For instance, the driving device may be an electric motor, a pneumatic drive, a piezo drive, etc.

The driving device may be configured to engage with a section of the conveying element to drive the conveying element in the conveying direction. The engagement between the driving device and the conveying element, in order to transfer a driving force from the driving device to the conveying element, may be based on friction and/or a form fit.

The handling installation may include a plurality of driving devices, each driving device being configured to engage with a section of the conveying element to drive the conveying element in the conveying direction.

The handling installation preferably includes a controller having a processing circuitry for automatically providing commands to components of the handling installation and/or for processing and forwarding manual commands entered, e.g., via a command receiving interface provided by the handling installation, by a user.

The conveying device may be configured to have a variable and/or adjustable speed. The speed of the conveying device is preferably a translational speed of the support surface. Preferably, the speed of the conveying device may be adjusted by varying a speed, preferably a rotational speed, of at least one driving element of the driving device(s). For instance, a controller, such as the controller described above, may be configured to automatically and/or manually control the speed of the conveying device or driving device(s), respectively. This may allow the speed of the conveying device or driving device(s), respectively, to be controlled. Controlling the speed of the conveying device or driving device(s), respectively, may be based on the available capacity of the processing plant and/or at least one processing station which is arranged upstream from the conveying device and/or downstream from the conveying device, with respect to the conveying direction. Thus, for instance, if the throughput of the food items along the conveying device surpasses the respective capacity, the speed of the conveying device or driving device(s), respectively, may be decreased and/or if the throughput of the food items lags behind the respective capacity, the speed of the conveying device or driving device(s), respectively, may be increased.

To automatically control the speed of the conveying device or driving device(s), respectively, the handling installation may include at least one detecting element, preferably an optical detecting element, such as a camera, configured to detect the throughput of the food items along the conveying device and provide information regarding the detected throughput, e.g., to a controller, preferably having or at least being associated with a processing circuitry to process the received information. The controller and/or the processing circuitry may be configured to compare the detected throughput with a target throughput or target range of throughput and adjust the speed of the driving device(s) or maintain the set speed of the driving device(s) if the detected throughput substantially matches the target throughput or is within a target range of throughput. The conveying device may be configured with a start-stop function as a speed control to stop and start the conveying device or driving device(s), respectively, on demand.

The handling installation may include a plurality of conveying devices. At least two conveying devices may be arranged parallel to each other and/or in series.

The dimensions of the conveying devices may be substantially the same. Alternatively, the dimensions of at least two conveying devices may be substantially different. For instance, two conveying devices may be arranged in series, a first conveying device arranged upstream from a second conveying device may have a greater width than the second conveying device. This may advantageous to ensure that the food items are arranged in a single layer on the second conveying device to facilitate handling and/or processing of the food items.

The speeds of conveying devices may also be controlled synchronously or independently. Preferably, two conveying devices may be arranged in series, a first conveying device being arranged upstream from a second conveying device. A speed of the second conveying device may be adjustable to be greater than a speed of the first conveying device. This may also be advantageous to ensure that the food items are arranged in a single layer on the second conveying device to facilitate handling and/or processing of the food items.

The handling installation further includes a rotating device including a rotatable housing configured to receive therein at least one food item from the conveying device. The housing is rotatably driven by at least one drive device about a housing rotation axis which is parallel to or coincident with the conveying direction to rotate the food item about an axis which is parallel to or coincident with the housing rotation axis, preferably about a longitudinal axis of the food item, and change an orientation of the food item.

The processing of food items may be made more efficient, effective and/or reliable if the handling of the respective food items is performed in a specific manner in preparation for the next processing step such that the processing step may be performed more quickly and/or efficiently.

For instance, for at least some processing steps at at least some food item processing station, a certain orientation of the food items may be desired and/or required to effectively and/or efficiently process the food items. For instance, for at least some processing steps at at least some processing station, it may be preferred or required that a certain feature of the food item is oriented in a certain direction relative to a respective processing device of the processing station. For instance, it may be desired or required that a certain section of the food item is oriented in a certain direction relative to a respective processing device of the processing station. In the case of processing fish, it may be required or desired that the underside of the fish, i.e., the belly side of the fish, be arranged in a certain, preferably predetermined, direction relative to a respective processing device of the processing station.

In some cases, robots have been employed to grasp the food items and feed the food items to the respective processing station in the required and/or desired orientation of the food items. However, the use of robots may be expensive and tedious to maintain, in particular with regard to repairs and/or services of the robots. Moreover, food items may be susceptible to damage when the robots grasp the food items. In addition, some food items are difficult, or even impossible, to be handled by a robot, e.g., due to the texture, size, or other features of the food items. Moreover, in general, reorienting food items, such as flipping or rotating the food items, is tedious and time-consuming to accomplish via a robot.

The rotating device including the rotatably driven housing, as described above, may provide a flipping or rotating means to flip (rotate) the food item from one side of the food item to a different side of the food item to change an orientation of the food item. The food item may be conveyed into the rotatable housing, e.g., by means of at least one conveying device. Once the fish is inside the housing, the housing may be rotated about the housing rotation axis which is parallel to or coincident with the conveying direction. By configuring the housing rotation axis to be parallel to or coincident with the conveying direction, the food items may be fed directly from a conveying device to the housing. Moreover, the food items may be released from the housing directly to a conveying device. Thus, the food items may be conveyed into and out of the housing in substantially the same direction. The food item may then be rotated, or flipped, about an axis which is parallel to or coincident with the housing rotation axis, preferably about a longitudinal axis of the food item. Thus, an orientation of the food item may be changed, e.g., so that a certain feature of the food item is oriented in a certain direction relative to a respective processing device of the processing station.

By rotating, or flipping, the food items about an axis which is parallel to or coincident with the conveying direction may mean that a first side of each food item is in contact with a surface of the housing prior to rotation and a second side, which is different from the first side, is in contact with a surface of the housing after rotation. The first side of the food item may be in contact with a different surface of the housing than the second side of the food item.

Advantageously, the rotating device may be deployed on demand. For instance, for some food items, the rotating device may not be deployed if no rotation of a particular food item or food items is not desired and/or required. This may increase the flexibility and user-friendliness of the handling installation.

Preparing the food items for the next processing step by optimizing the orientation of the food items based on the circumstances of the next processing step, said processing step may be performed more quickly, reliably and/or efficiently.

Preferably, the housing has an interior surface configured to receive the food item thereon, wherein the interior surface includes a plurality of edges, each edge preferably extending substantially parallel to the housing rotation axis, for effecting a rotation of the food item about an axis which is parallel to or coincident with the housing rotation axis, preferably about a longitudinal axis of the food item, when the food item is received in the housing, to rotate the food item and change an orientation of the food item. Thus, as the housing is rotated, each food item may slide along the interior surface of the housing towards one of the edges. As the food item reaches the edges, the food item is rotated, or flipped, to the angle of surface provided at the edge. This may provide a simple and reliable means for rotating, or flipping, the food items. The flipping effect may be increased by decreasing the angle at the edge which is formed between the two adjacent surfaces of the interior surface of the housing which are adjoined at the edge.

Preferably, the interior surface is, in a cross-section which is substantially perpendicular to the housing rotation axis, polygonal shaped, preferably triangular shaped. The shape of the cross-section of the interior surface of the housing may determine the amount of edges which are provided therein for flipping, or rotating, the food items. Thus, increasing the number of edges provided may reduce the amount of rotation of the housing required to flip the food item.

Preferably, the rotating device includes a drive force transmitting member, preferably a drive force transmitting belt, coupled to the drive device, wherein the drive force transmitting member extends at least partially around the housing to transfer forces from the drive device to the housing in order to rotate the housing about the housing rotation axis. By providing a drive force transmitting member which extends at least partially around the housing, a reliable and robust force transfer mechanism to transfer forces from the drive device to the housing may be provided. Such a force transfer mechanism may induce low costs and require low maintenance, in particular due to the robustness of the force transfer mechanism and the direct connection to the housing, which may require a relatively small number of parts. Thus, a simple, reliable and efficient means of transferring forces from the drive device to the housing may be provided. The drive force transmitting member may directly or indirectly engage the housing to transfer forces from the drive device to the housing.

Preferably, the rotating device includes an encompassing member, preferably a circular pipe, within which the housing is at least partially arranged and to which the housing is fixedly attached, wherein the drive force transmitting member engages with an outer surface of the encompassing member to transfer forces from the drive device to the housing in order to rotate the housing about the housing rotation axis. The encompassing member may provide a protective cover to protect the housing from external influences. Moreover, since the drive force transmitting member engages with an outer surface of the encompassing member, the force transmitting member and the housing are indirectly connecting. This may increase the flexibility in configuring the housing, i.e., the dimensions and/or the shape of the housing since the direct engagement of the force transmitting member with the housing does not have to be considered as a factor when configuring the housing. For instance, the housing may have a substantially triangular cross-section and the encompassing member may have a substantially circular cross-section. Moreover, transfer forces from the drive device to the housing via the outer surface of the encompassing member may provide a simple, reliable and efficient means of transferring forces from the drive device to the housing.

Preferably, at least a portion of the rotating device, preferably the encompassing member, is supported on at least one rolling member configured to rotate about a rolling member rotation axis to directly or indirectly support the housing and to allow at least the housing to rotate about the housing rotation axis. This may provide a simple and effective means of enabling the housing to rotate about the housing rotation axis to rotate, or flip, the food items. The rolling member may be provided with a braking device by means of which the rotation of the housing may be stopped, or at least reduced. Alternatively, or additionally, the rolling member may be provided with a drive means to drive the rolling member and thus drive the housing to rotate.

Preferably, the handling installation further includes at least one support structure which directly or indirectly supports at least the housing, and preferably also the encompassing member. The support structure may be adjustable to change a distance between the housing rotation axis and a surface on which the rotating device is arranged. By enabling the distance between the housing rotation axis and a surface on which the rotating device is arranged to be adjustable, the rotating device may, for instance, be moved to different positions during operation. For instance, the rotating device may be moved to a higher position when the housing is rotating to flip, or rotate, a food item located in the housing. This may prevent the food item from moving further along in the conveying direction, as the food item is arranged in the housing, by means of the conveying device and/or a further conveying device which may be arranged downstream from the rotating device, with respect to the conveying direction. This may also improve the safety of the handling installation, e.g., by moving the rotating device substantially away from personnel and/or objects located in the vicinity of the housing during rotation of the housing. When no flipping, or rotating, of a particular food item or food items is required and/or desired, the food item(s) may be conveyed through the non-rotating housing, e.g., by means of the conveying device and/or a further conveying device which may be arranged downstream from the rotating device.

Preferably, the handling installation further includes at least one lift actuator configured to change the distance between the housing rotation axis and the surface on which the rotating device is arranged.

The object of the invention identified at the beginning is also achieved by a method for handling food items.

The effects, advantages and various embodiments described above in conjunction with the handling installation also apply to the method accordingly.

The method includes the following steps:
conveying a plurality of food items on at least one support surface of at least one conveying device, the conveying device being driven by at least one driving device to move the support surface along a conveying direction to convey the food items in the conveying direction;
   feeding at least one food item from the support surface into a housing of a rotating device arranged downstream from the conveying device, with respect to the conveying direction, rotating the food item in the housing by rotating the housing by means of least one drive device about a housing rotation axis which is parallel to or coincident with the conveying direction to rotate the food item about an axis which is parallel to or coincident with the housing rotation axis, preferably about a longitudinal axis of the food item, and change an orientation of the food item.

The object of the invention identified at the beginning is also achieved by a handling installation for handling food items according to a third aspect of the invention.

The handling installation includes at least one conveying device having at least one support surface configured to support a plurality of food items. The conveying device is driven by at least one driving device to move the support surface along a conveying direction to convey the food items in the conveying direction.

The support surface may be substantially planar at least in a section thereof. The support surface may include slip-reducing features which may prevent, or at least reduce, slipping of the food items on the support surface as the food items are being conveyed in the conveying direction. For instance, the support surface may be formed irregularly in at least some sections thereof. For instance, the support surface may have textured and/or roughened sections and/or protrusions extending from the support surface. Such slip-reducing features may increase friction between the support surface and the food items as the food items are being conveyed in the conveying direction.

The conveying device may include a conveying element, such as a belt, preferably an endless belt, which at least partially defines the support surface. The conveying element may have a substantially continuous surface to provide a continuous support surface for the food items to lie on. The conveying element may be flexible. Moreover, the conveying element may be permeable to water to allow water, which may adhere to or be transported with the food items, for instance a fish, to drain from the support surface.

An alternative conveying element, i.e., besides a belt, may also be used, such as a plurality of interconnected movable plates or a fabric, such as a plain-woven fabric.

The driving device may be any device capable of converting energy into motion to drive the conveying device into motion. For instance, the driving device may be an electric motor, a pneumatic drive, a piezo drive, or other driving devices.

The driving device may be configured to engage with a section of the conveying element to urge the conveying element to move in the conveying direction. The engagement between the driving device and the conveying element may be based on friction and/or a form fit.

The handling installation may include a plurality of driving devices, each driving device being configured to engage with a section of the conveying element to urge the conveying element to move in the conveying direction.

The handling installation preferably includes a controller having a processing circuitry for automatically providing commands to components of the handling installation and/or for processing and forwarding manual commands entered by a user.

The driving device(s) may be configured to be speed-variable, wherein the speed is preferably a rotational speed of a rotating element of the driving device(s). For instance, a controller, such as the controller described above, may be configured to automatically and/or manually control the speed of the driving device(s). This may allow the speed of the driving device(s) to be controlled based on the available capacity in the processing plant and/or at a processing stations which is arranged prior to, i.e., upstream from, the conveying device and/or after, i.e., downstream from, the conveying device. Thus, for instance, if the throughput of the food items through the conveying device surpasses the respective capacity, the speed of the driving device(s) may be decreased and/or if the throughput of the food items lags behind the respective capacity, the speed of the driving device(s) may be increased.

To automatically control the speed of the driving device(s) the handling installation may include detecting elements configured to detect the throughput of the food items through the conveying device and provide information regarding the detected throughput to a controller. The controller may be configured to compare the detected throughput with a target throughput or target range of throughput and adjust the speed of the driving device(s) or maintain the set speed of the driving device(s) if the detected throughput substantially matches the target throughput or is within a target range of throughput.

The handling installation further includes a rotating device including at least one deflecting device, the deflecting device being positionable, preferably movable in a plane which is substantially parallel to the support surface, from a non-deflecting position, in which the food item may pass the deflecting device without being deflected, and a deflecting position, in which the deflecting device extends along at least a section of the support surface to exert a force to the food item as the food item is being conveyed on the support surface and deflect the food item away from the conveying direction to rotate the food item about an axis which is substantially perpendicular to the support surface and/or about a transverse axis of the food item to change an orientation of the food item.

As detailed further above, the processing of food items may be made more efficient, effective and/or reliable if the handling of the respective food items is performed in a specific manner in preparation for the next processing step such that the processing step may be performed more quickly and/or efficiently.

For instance, for at least some processing steps at at least some food item processing stations, a certain orientation of the food items may be desired and/or required to effectively and/or efficiently process the food items. For instance, for at least some processing steps at at least some processing stations, it may be preferred or required that a certain feature of the food item is oriented in a certain direction relative to a respective processing device of the processing station. For instance, it may be desired or required that a certain section of the food item is oriented in a certain direction relative to a respective processing device of the processing station. In the case of processing fish, it may be required or desired that the head or the tail of the fish be arranged in a certain, preferably predetermined, direction relative to a respective processing device of the processing station.

In some cases, robots have been employed to grasp the food items and feed the food items to the respective processing station in the required and/or desired orientation of the food items. However, the use of robots may be expensive and tedious to maintain, in particular with regard to repairs and/or services of the robots. Moreover, food items may be susceptible to damage when the robots grasp the food items. In addition, some food items are difficult, or even impossible, to be handled by a robot, e.g., due to the texture, size, or other features of the food items. Moreover, in general, reorienting food items, such as flipping or rotating the food items, is tedious and time-consuming to accomplish via a robot.

The rotating device including the deflecting device may provide a handling means which can selectively change the orientation of a food item. When the deflecting device is in the deflecting position, a force may be exerted to the food item as the food item is being conveyed on the support surface and deflect the food item away from the conveying direction to rotate the food item to a desired orientation. As a result, a certain feature of the food item is oriented in a certain direction relative to a respective processing device of the processing station. For instance, a desired and/or required orientation of the tail or head of a fish direction relative to a respective processing device of the processing station and/or relative to the conveying direction may be achieved.

The deflecting device may be stationary as the deflecting device exerts a force to the food item. Alternatively, the deflecting device may be moved for at least a portion of the duration during which the deflecting device exerts a force to the food item. By moving the deflecting device, a force which is exerted on the food item may be increased. In addition, this may increase control over the movement and/or rotation of the food item caused by the deflection.

The deflecting device may be positioned manually and/or automatically. For this purpose, the handling installation may include a controller configured to automatically and/or manually control the movement of the deflecting device.

For the purpose of manually positioning the deflecting device, the controller may be configured to receive commands from a user for controlling the movement of the deflecting device. The handling installation may include a command receiving interface configured to enable the user to input commands for controlling the movement of the deflecting device into the command receiving interface which are provided to the controller.

For the purpose of automatically moving the deflecting device, the handling installation may include at least one detecting element configured to detect a food item and/or an orientation of the food item and provide information regarding the detected food item and/or orientation of the food item. The controller may be configured to initiate movement of the deflecting device based on the information provided by the detecting element.

The deflecting device may be a, preferably planar, plate-like element. The deflecting device may have at least two side surfaces, which are preferably parallel. The side surfaces may provide a resistance force against a food item to deflect the food item away from its initial path and away from another food item. The deflecting device may have a shape which is suited and/or adapted to the specific application. For example, the deflecting device may be rectangular, triangular, polygonal, etc., when viewed from the side surface of the deflecting device.

The deflecting device may be a gate-like element, e.g., an elongated arm, to selectively block the conveying path of the food item as the food item is being conveyed on the support surface.

Preferably, the handling installation further includes a platform member, preferably a tray, which is stationary, the platform member having a resting surface which is adjacent to the support surface of the conveying device and configured to receive a portion of the food item as the food item is being deflected by the deflecting device. The deflecting device may be configured to deflect the food items onto the resting surface such that a portion of the food items remains on the support surface of the conveying device. Thus, the platform member may provide an additional surface, i.e., in addition to the support surface, for the portion of the food item to rest on as the food item is being rotated. Due to the platform member being stationary and the support surface of the conveying device exert a force on the other portion of the food item, i.e., the portion which is not arranged on the platform member, a moment is exerted on the food item about the axis of rotation of the food item, i.e., about an axis which is substantially perpendicular to the support surface and/or about a transverse axis of the food item to change an orientation of the food item. This may provide a simple, reliable and efficient means of changing the orientation of the food items.

Preferably, the platform member is arranged on a first side of the conveying device and the deflecting device is arranged on a second side of the conveying device, the first side being substantially opposite from the second side. Thus, the deflecting device may exert a pushing force on the food item such that a portion of the food item may be pushed onto the platform member.

Preferably, the deflecting device includes an elongated arm which is mounted to be rotatable about a deflecting device rotation axis, wherein the elongated arm is rotatable about the deflecting device rotation axis by means of at least one drive device from a non-deflecting position, in which the food item may pass the elongated arm without being deflected, and a deflecting position, in which the elongated arm extends along at least a section of the support surface to exert a force to the food item as the food item is being conveyed on the support surface and deflect the food item away from the conveying direction to rotate the food item and change its orientation. By configuring the deflecting device as an elongated arm which is rotatable between said non-deflecting position and said deflecting position, an effective deflection of the food items may be provided while the deflecting device is in the deflecting position, whereas the deflecting device may be stowed away in the non-deflecting position when rotation of food items by the deflecting device is not required and/or desired. This may reduce the intrusiveness of the deflecting device when the deflecting device is not required and/or desired.

Preferably, the elongated arm, when in the deflecting position, extends diagonally along at least a section of the support surface such that the elongated arm forms an angle with the conveying direction of the conveying device from 20° to 80°, preferably from 30° to 80°, more preferably from 40° to 80°, more preferably from 50° to 80°, most preferably from 60° to 80°. The above-identified angular ranges may allow a deflection of the food item to rotate said food item while still allowing at least a reduced transport of the food item along the conveying direction. Thus, a complete blockage of the transport of the food item along the conveying direction may be prevented.

Preferably, the platform member includes a guiding element which extends at an angle to the resting surface from 60° to 120°, preferably from 70° to 110°, more preferably from 80° to 100°, wherein the guiding element is configured to:
actively and/or passively exert a force to the food item to deflect the food item away from the platform member and back onto the conveying surface of the conveying device; and/or limit a deflection movement of the food item as the food item is being deflected by the deflecting device. The guiding element may provide a means for urging the food item back onto the conveying surface after a portion of the food item has been deflected onto the platform member by means of the deflecting device.

Preferably, the handling installation further includes at least one detection device, preferably an optical detection device, configured to detect each food item on the conveying device(s) and provide information related to a location and/or an orientation of the food items. The information may include at least one of the following: an angle between an axis, preferably a longitudinal axis, of the food item and a conveying direction of the food item, a length of the food item along the conveying direction of the food item, a distance of the food item to a border of the conveying device(s), an orientation of the food item relative to the conveying direction and an orientation of a pre-determined feature of the food item in at least a section of the food item relative to the conveying direction of the food item and/or to a predetermined side of the conveying device. Based at least partially on the information, the controller, or a processing circuitry included in the controller or at least associated with the controller, may determine whether a cluster of food items is present. If it is determined that a cluster of food items is present, the actuating device may be actuated automatically to deploy the deflecting device to the deflecting position.

Preferably, the information provided by the detection device includes at least an orientation of a pre-determined feature of the food item in at least a section of the food item relative to the conveying direction and/or to a predetermined side of the conveying device.

Preferably, the deflecting device is positionable, preferably by means of a controller and at least one actuator communicatively coupled to the controller, in the non-deflecting position and/or the deflecting position based at least partially on the information provided by the detection device, preferably automatically by means of the controller and the actuator.

Preferably, the handling installation further includes an alignment device arranged in a conveying path of the food items and configured to substantially align an axis, preferably a longitudinal axis, of the food item to the conveying direction and/or a predetermined axis, the alignment device including at least two wall segments which converge together in the conveying direction. The alignment device may adjust the orientation of an axis of the food item to the conveying direction and/or a predetermined axis, e.g., to correct or at least reduce a misalignment of said axis.

The object of the invention identified at the beginning is also achieved by a food processing installation according to a fourth aspect of the invention.

The food processing installation includes at least one food processing station configured to process food items and at least one food handling installation according to any of the embodiments described herein. The food handling installation is configured to handle the food items and feed the food items to the food processing station(s).

The object of the invention identified at the beginning is also achieved by a method for handling food items.

The effects, advantages and various embodiments described above in conjunction with the handling installation also apply to the method accordingly.

The method includes the following steps:
conveying a plurality of food items on at least one support surface of at least one conveying device, the conveying device being driven by at least one driving device to move the support surface along a conveying direction to convey the food items in the conveying direction;
deflecting at least one food item by means of at least one deflecting device by positioning, preferably moving in a plane which is substantially parallel to the support surface, the deflecting device from a non-deflecting position, in which the food item may pass the deflecting device without being deflected, to a deflecting position, in which the deflecting device extends along at least a section of the support surface to exert a force to the food item as the food item is being conveyed on the support surface and deflect the food item away from the conveying direction to rotate the food item about an axis which is substantially perpendicular to the support surface and/or about a transverse axis of the food item to change an orientation of the food item.

The following list of aspects provides alternative and/or further features of the invention:
1. A handling installation for handling food items, preferably fish, the handling installation including:
   at least one conveying device having at least one support surface configured to support a plurality of food items, wherein the conveying device is driven by at least one driving device to move the support surface along a conveying direction to convey the food items in the conveying direction; and
   at least one separating device, preferably arranged downstream from the conveying device, with respect to the conveying direction, the separating device being configured to at least partially separate clusters of food items which are conveyed on the support surface;
   wherein the separating device has at least one conveying space through which the food items can be conveyed, preferably by means of a gravitational force, and at least one deflecting device being positionable to at least partially protrude into the conveying space to deflect at least one first food item at least partially away from at least one second food item in order to increase the spacing between at least the first food item and the second food item to separate a food cluster.
2. The handling installation according to aspect 1, wherein the separating device has a floor which at least partially delimits the conveying space and along which the food items can be conveyed through the conveying space, wherein the deflecting device is positionable to protrude through at least a portion of the floor and into the conveying space.
3. The handling installation according to aspect 1 or 2, wherein the deflecting device, when the deflecting device is positioned to protrude at least partially into the conveying space, partitions at least a section of the conveying space into at least two, preferably at least three, more preferably at least four, conveying space channels through which the food items can be separately conveyed.
4. The handling installation according to aspect 2 or 3, wherein the floor is declined, in the conveying direction of the conveying device, relative to a horizontal plane, when the handling installation is in an operating position, and/or relative to the support surface of the conveying device.
5. The handling installation according to any of the preceding aspects, wherein the deflecting device is movable between a first position, preferably a non-deflecting position, in which the deflecting device is retracted from the conveying space, and a second position, preferably a deflecting position, in which the deflecting device protrudes at least partially into the conveying space to deflect the at least one first food item at least partially away from the at least one second food item in order to increase the spacing between at least the first food item and the second food item to separate a food cluster.
6. The handling installation according to any of the preceding aspects, further including at least one actuating device operatively coupled with at least the deflecting device, and optionally also including a controller operatively coupled with the actuating device, wherein the actuating device is configured to move the deflecting device between the non-deflecting position and the deflecting position, preferably on demand, preferably automatically based on at least one command which the controller is configured to provide.
7. The handling installation according to any of the preceding aspects, wherein, when the deflecting device is positioned to protrude at least partially into the conveying space, the deflecting device protrudes into the conveying space by a first distance at a first position and by a second distance at a second position, the second position preferably being downstream from the first position with respect to a conveying direction of the food items, wherein the second distance is greater than the first distance.
8. The handling installation according to any of the preceding aspects, wherein the deflecting device is an elongated body, preferably a substantially planar and elongated body, having a longitudinal axis which is angled relative to a vertical plane which extends in or along the conveying direction of the conveying device and/or relative to a longitudinal median plane of the conveying device and/or relative to a longitudinal median plane of the conveying device in which a longitudinal axis of the conveying device, which preferably extends along the conveying direction of the conveying device, lies, when the handling installation is in an operating position.
9. The handling installation according to any of the preceding aspects, wherein the separating device includes a plurality of deflecting devices, wherein preferably at least two of the deflecting devices are positionable and/or actuatable independently from one another to at least partially protrude into the conveying space simultaneously or non-simultaneously.
10. The handling installation according to any of the preceding aspects, including at least two conveying devices arranged in series, in a conveying direction of the food items, each conveying device having at least one support surface configured to support a plurality of food items and each conveying device being driven by at least one driving device to move the support surface along a conveying direction to convey the food items in the conveying direction, respectively, wherein a first conveying device of the at least two conveying devices is operable at a first conveying speed and a second conveying device of the at least two conveying devices, which is downstream from the first conveying device with respect to the conveying direction of the food items, is simultaneously operable at a second conveying speed, the first conveying speed and the second conveying speed being adjustable to differ from each other, preferably the first conveying speed being lower than the second conveying speed.
11. The handling installation according to any of the preceding aspects, including a plurality of separating devices arranged in series, with respect to a conveying direction of the food items, each separating device having at least one conveying space through which the food items can be conveyed in a respective conveying direction and at least one deflecting device, wherein:
   a longitudinal axis of at least one deflecting device of a first separating device of the plurality of separating devices is angled by a first separating device angle relative to a vertical plane which extends in or along the conveying direction of the conveying device and/or relative to a longitudinal median plane of the conveying device and/or relative to a longitudinal median plane of the conveying device in which a longitudinal axis of the conveying device, which preferably extends along the conveying direction of the conveying device, lies, when the handling installation is in an operating position; and
   a longitudinal axis of at least one deflecting device of a second separating device of the plurality of separating devices is angled by a second separating device angle relative to the vertical plane which extends in or along the conveying direction of the conveying device and/or relative to the longitudinal median plane of the conveying device and/or relative to the longitudinal median plane of the conveying device in which a longitudinal axis of the conveying device, which preferably extends along the conveying direction of the conveying device, lies, when the handling installation is in an operating position, the second separating device angle being different than the first separating device angle.
12. The handling installation according to aspect 11, wherein each conveying space of the separating device extends along a respective centerline along which the food items can be conveyed, wherein:
   the centerline of the conveying space of a first separating device of the plurality of separating devices is angled by a first conveying space angle relative to the vertical plane and/or relative to the longitudinal median plane of the conveying device and/or relative to the longitudinal median plane of the conveying device in which a longitudinal axis of the conveying device, which preferably extends along the conveying direction of the conveying device, lies, when the handling installation is in an operating position,; and
   the centerline of the conveying space of a second separating device of the plurality of separating devices is angled by a second conveying space angle relative to the vertical plane and/or relative to the longitudinal median plane of the conveying device and/or relative to the longitudinal median plane of the conveying device in which a longitudinal axis of the conveying device, which preferably extends along the conveying direction of the conveying device, lies, when the handling installation is in an operating position, the second conveying space angle being different than the first conveying space angle.
13. The handling installation according to aspect 11 or 12, wherein:
   the longitudinal axis of at least one deflecting device of the first separating device and the longitudinal axis at least one deflecting device of the second separating device are angled towards opposite sides of the vertical plane and/or the longitudinal median plane of the conveying device and/or the longitudinal median plane of the conveying device in which a longitudinal axis of the conveying device, which preferably extends along the conveying direction of the conveying device, lies, when the handling installation is in an operating position;
   and/or
   the centerline of the conveying space of the first separating device and the centerline of the conveying space of the second separating device are angled towards opposite sides of the vertical plane and/or the longitudinal median plane of the conveying device and/or the longitudinal median plane of the conveying device in which a longitudinal axis of the conveying device, which preferably extends along the conveying direction of the conveying device, lies, when the handling installation is in an operating position.
14. The handling installation according to any of aspects 11 to 13, including at least two conveying devices arranged in series, with respect to a conveying direction of the food items, each conveying device having at least one support surface configured to support a plurality of food items and each conveying device being driven by at least one driving device to move the support surface along a conveying direction to convey the food items in the conveying direction, respectively, wherein each separating device of the plurality of separating devices is arranged downstream from and adjacent to a respective one of the conveying devices such that the food items are fed directly from the respective conveying device to the respective separating device.
15. The handling installation according to any of the preceding aspects, further including at least one detection device, preferably an optical detection device, configured to detect each food item on the conveying device(s) and/or the separating device(s) and provide information related to a location and/or an orientation of each food item, wherein at least one deflecting device is positionable and/or a conveying speed of at least one conveying device and/or conveying speeds of a plurality of conveying devices is/are adjustable, preferably by means of a controller and optionally at least one actuator communicatively coupled to the controller, based at least partially on the information provided by the detection device, preferably the controller and the actuator being configured to perform the positioning and/or adjusting automatically.
16. The handling installation according to aspect 15, including a plurality of detection devices, preferably optical detection devices, each being associated with one of the conveying devices and with the respective separating device arranged downstream from and adjacent to the respective conveying device, the detection devices being configured to detect each food item on the respective conveying device and/or the respective separating device and provide information related to a location and/or an orientation of each food item, wherein each deflecting device is positionable and/or a conveying speed of the conveying device and/or conveying speeds of a plurality of conveying devices is/are adjustable, preferably by means of a controller and optionally at least one actuator communicatively coupled to the controller, based at least partially on the information provided by the associated detection device, preferably the controller and the actuator being configured to perform the positioning and/or adjusting automatically.
17. The handling installation according to aspect 16, wherein the information provided by the detection device includes at least one of the following: an angle between an axis, preferably a longitudinal axis, of the food item and a conveying direction of the food item, a length of the food item along the conveying direction of the food item, a distance of the food item to a border of the conveying device(s) and/or the separating device(s), an orientation of the food item relative to the conveying direction and an orientation of a pre-determined feature of the food item in at least a section of the food item relative to the conveying direction of the food item and/or to a predetermined side of the conveying device.
18. The handling installation according to any of the preceding aspects, wherein the separating device is configured to provide a plurality of lanes, preferably at least 2 lanes, more preferably at least 3 lanes, in each of which food items can be conveyed, preferably in a single file.
19. The handling installation according to aspect 18, wherein the separating device is configured such that the food items are spaced apart from each other in each lane, in the conveying direction, preferably by a regular distance.
20. The handling installation according to any of the preceding aspects, further including at least one gripping device configured to move, preferably by at least partially, preferably completely, lifting at least a portion of each food item, preferably wherein the at least one gripping device is arranged downstream and/or upstream from the separating device.
21. The handling installation according to aspect 20, wherein the one or more gripping devices include one or more engaging devices configured to engage each food item, preferably individually, to move, preferably sort, the respective food item, preferably by at least partially, preferably completely, lifting the respective food item in a non-invasive manner.
22. The handling installation according to any of the preceding aspects, wherein the deflecting device is configured to deflect the at least one first food item at least partially away from the at least one second food item in a non-invasive manner.
23. A method for handling food items, including the following steps:
   conveying a plurality of food items on at least one support surface of at least one conveying device, the conveying device being driven by at least one driving device to move the support surface along a conveying direction to convey the food items in the conveying direction;
   feeding the plurality of food items from the support surface of the conveying device to a conveying space of a separating device arranged downstream from the conveying device, with respect to the conveying direction, the food items being conveyed through the conveying space;
   at least partially separating clusters of food items which are conveyed on the support surface and/or in the conveying space by positioning at least one deflecting device of the separating device to at least partially protrude into the conveying space to deflect at least one first food item at least partially away from at least one second food item in order to increase the spacing between at least the first food item and the second food item.
24. A handling installation for handling food items, preferably fish, including:
   at least one conveying device having at least one support surface configured to support a plurality of food items, wherein the conveying device is driven by at least one driving device to move the support surface along a conveying direction to convey the food items in the conveying direction; and
   a rotating device including a rotatable housing configured to receive therein at least one food item from the conveying device, wherein the housing is rotatably driven by at least one drive device about a housing rotation axis, which is preferably parallel to or coincident with the conveying direction, to rotate the food item about an axis, which is preferably parallel to or coincident with the housing rotation axis, preferably about a longitudinal axis of the food item, and change an orientation of the food item.
25. The handling installation according to aspect 24, wherein the housing has an interior surface configured to receive the food item thereon, wherein the interior surface includes a plurality of edges, each edge preferably extending substantially parallel to the housing rotation axis, for effecting a rotation of the food item about an axis which is parallel to or coincident with the housing rotation axis, preferably about a longitudinal axis of the food item, when the food item is received in the housing, to rotate the food item and change an orientation of the food item.
26. The handling installation according to aspect 25, wherein the interior surface is, in a cross-section which is substantially perpendicular to the housing rotation axis, polygonal shaped, preferably triangular shaped.
27. The handling installation according to any of aspects 24 to 26, wherein the rotating device includes a drive force transmitting member, preferably a drive force transmitting belt, coupled to the drive device, wherein the drive force transmitting member extends at least partially around the housing to transfer forces from the drive device to the housing in order to rotate the housing about the housing rotation axis.
28. The handling installation according to aspect 27, wherein the rotating device includes an encompassing member, preferably a circular pipe, within which the housing is at least partially arranged and to which the housing is preferably fixedly attached, wherein the drive force transmitting member engages with an outer surface of the encompassing member to transfer forces from the drive device to the housing in order to rotate the housing about the housing rotation axis.
29. The handling installation according to any of aspects 24 to 28, wherein at least a portion of the rotating device, preferably the encompassing member, is supported on at least one rolling member configured to rotate about a rolling member rotation axis to directly or indirectly support the housing and to allow at least the housing to rotate about the housing rotation axis.
30. The handling installation according to any of aspects 24 to 29, further including at least one support structure which directly or indirectly supports at least the housing, and preferably also the encompassing member, wherein the support structure is adjustable to change a distance between the housing rotation axis and a surface on which the rotating device is arranged.
31. The handling installation according to aspect 30, further including at least one lift actuator configured to change the distance between the housing rotation axis and the surface on which the rotating device is arranged.
32. A method for handling food items, including the following steps:
   conveying a plurality of food items on at least one support surface of at least one conveying device, the conveying device being driven by at least one driving device to move the support surface along a conveying direction to convey the food items in the conveying direction;
   feeding at least one food item from the support surface into a housing of a rotating device arranged downstream from the conveying device, with respect to the conveying direction,
   rotating the food item in the housing by rotating the housing by means of least one drive device about a housing rotation axis which is parallel to or coincident with the conveying direction to rotate the food item about an axis which is parallel to or coincident with the housing rotation axis, preferably about a longitudinal axis of the food item, and change an orientation of the food item.
33. A handling installation for handling food items, preferably fish, including:
   at least one conveying device having at least one support surface configured to support a plurality of food items, wherein the conveying device is driven by at least one driving device to move the support surface along a conveying direction to convey the food items in the conveying direction; and
   a rotating device including at least one deflecting device, the deflecting device being positionable, preferably movable in a plane which is substantially parallel to the support surface, from a first position, preferably a non-deflecting position, in which the food item may pass the deflecting device without being deflected, and a second position, preferably a deflecting position, in which the deflecting device extends along at least a section of the support surface to exert a force to the food item as the food item is being conveyed on the support surface and deflect the food item away from the conveying direction to rotate the food item about an axis which is substantially perpendicular to the support surface and/or about a transverse axis of the food item to change an orientation of the food item.
34. The handling installation according to aspect 33, further including a platform member, preferably a tray, which is stationary, the platform member having a resting surface which is adjacent to the support surface of the conveying device and configured to receive a portion of the food item as the food item is being deflected by the deflecting device, wherein the deflecting device is configured to deflect the food items onto the resting surface such that a portion of the food items remains on the support surface of the conveying device.
35. The handling installation according to aspect 34, wherein the platform member is arranged on a first side of the conveying device and the deflecting device is arranged on a second side of the conveying device, the first side preferably being substantially opposite from the second side.
36. The handling installation according to any of aspects 33 to 35, wherein the deflecting device includes an elongated arm which is mounted to be rotatable about a deflecting device rotation axis, wherein the elongated arm is rotatable about the deflecting device rotation axis by means of at least one drive device from a non-deflecting position, in which the food item may pass the elongated arm without being deflected, and a deflecting position, in which the elongated arm extends along at least a section of the support surface to exert a force to the food item as the food item is being conveyed on the support surface and deflect the food item away from the conveying direction to rotate the food item and change its orientation.
37. The handling installation according to aspect 36, wherein the elongated arm, when in the deflecting position, extends diagonally along at least a section of the support surface such that the elongated arm forms an angle with the conveying direction of the conveying device from 20° to 80°, preferably from 30° to 80°, more preferably from 40° to 80°, more preferably from 50° to 80°, most preferably from 60° to 80°.
38. The handling installation according to any of aspects 34 to 37, wherein the platform member includes a guiding element which extends at an angle to the resting surface from 60° to 120°, preferably from 70° to 110°, more preferably from 80° to 100°, wherein the guiding element is configured to:
   actively and/or passively exert a force to the food item to deflect the food item away from the platform member and back onto the conveying surface of the conveying device; and/or
   limit a deflection movement of the food item as the food item is being deflected by the deflecting device.
39. The handling installation according to any of aspects 33 to 38, further including at least one detection device, preferably an optical detection device, configured to detect each food item on the conveying device(s) and provide information related to a location and/or an orientation of the food items.
40. The handling installation according to aspect 39, wherein the information provided by the detection device includes at least an orientation of a pre-determined feature of the food item in at least a section of the food item relative to the conveying direction and/or to a predetermined side of the conveying device.
41. The handling installation according to aspect 39 or 40, wherein the deflecting device is positionable, preferably by means of a controller and at least one actuator communicatively coupled to the controller, in the non-deflecting position and/or the deflecting position based at least partially on the information provided by the detection device, preferably automatically by means of the controller and the actuator.
42. The handling installation according to any of aspects 33 to 41, further including an alignment device arranged in a conveying path of the food items and configured to substantially align an axis, preferably a longitudinal axis, of the food item to the conveying direction and/or a predetermined axis, the alignment device including at least two wall segments which converge together in the conveying direction.
43. A food processing installation including at least one food processing station configured to process food items and a food handling installation according to any of aspects 1 to 22, 24 to 31, and 33 to 42, the food handling installation being configured to handle the food items and feed the food items to the food processing station(s).
44. A method for handling food items, including the following steps:
   conveying a plurality of food items on at least one support surface of at least one conveying device, the conveying device being driven by at least one driving device to move the support surface along a conveying direction to convey the food items in the conveying direction;
   deflecting at least one food item by means of at least one deflecting device by positioning, preferably moving in a plane which is substantially parallel to the support surface, the deflecting device from a non-deflecting position, in which the food item may pass the deflecting device without being deflected, to a deflecting position, in which the deflecting device extends along at least a section of the support surface to exert a force to the food item as the food item is being conveyed on the support surface and deflect the food item away from the conveying direction to rotate the food item about an axis which is substantially perpendicular to the support surface and/or about a transverse axis of the food item to change an orientation of the food item.

Preferred embodiments of the present invention are further elucidated below with reference to the figures. The described embodiments do not limit the present invention.

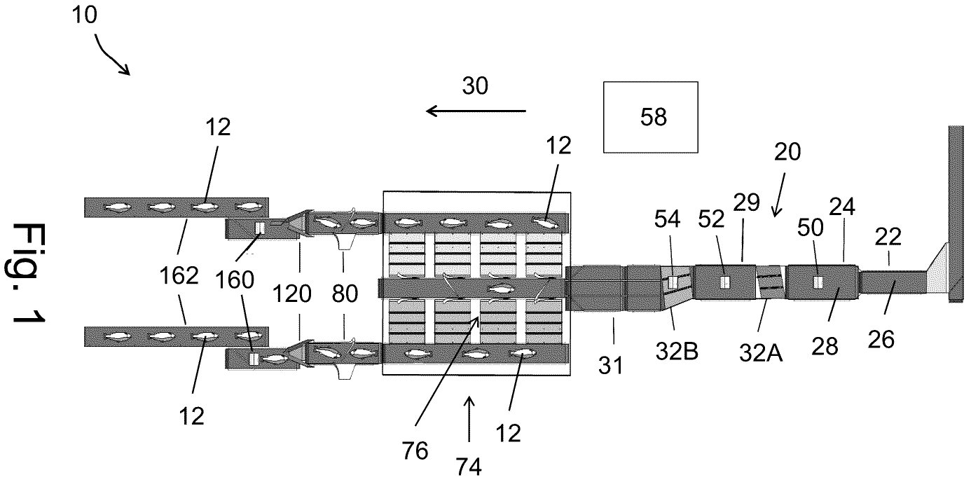

FIG. 1 shows a schematic top view of a food processing installation according to an embodiment of the invention;

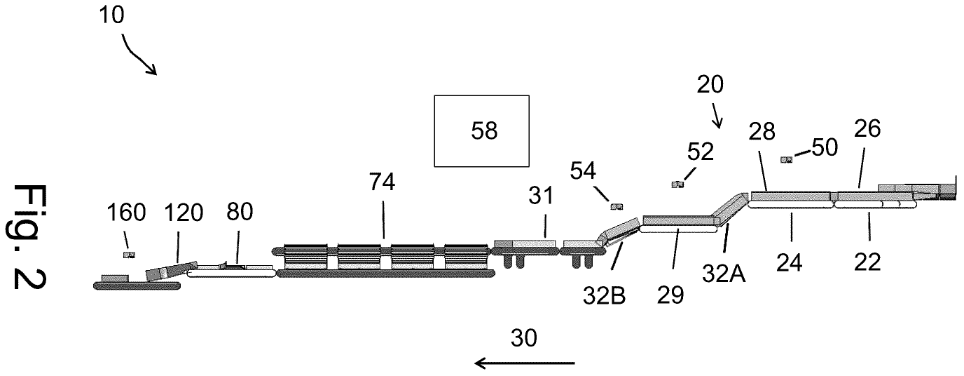

FIG. 2 shows a schematic side view of the food processing installation of FIG. 1;

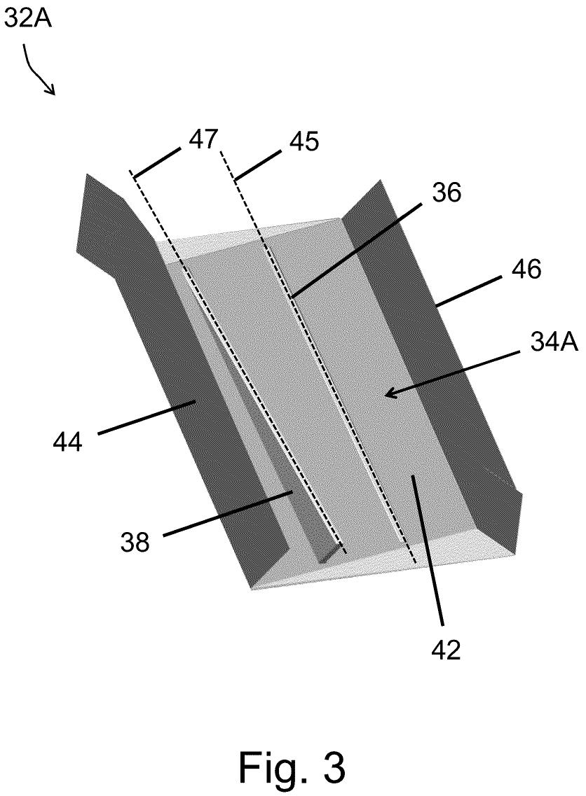

FIG. 3 shows an enlarged perspective view of a handling installation included in the food processing installation of FIGS. 1 and 2 according to an embodiment of the invention;

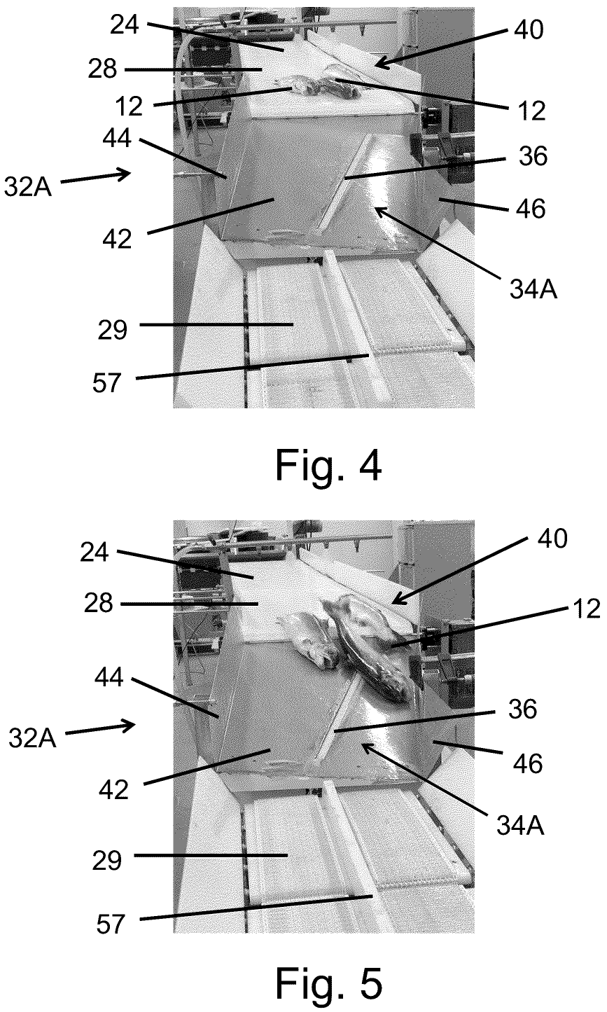

FIG. 4 shows a perspective view of the handling installation of FIG. 3 as a cluster of food items is being conveyed on a conveying device towards a separating device;

FIG. 5 shows a perspective view of the handling installation of FIGS. 3 and 4 as the cluster of food items is adjacent to a deflecting device of the separating device, before the deflecting device has been deployed;

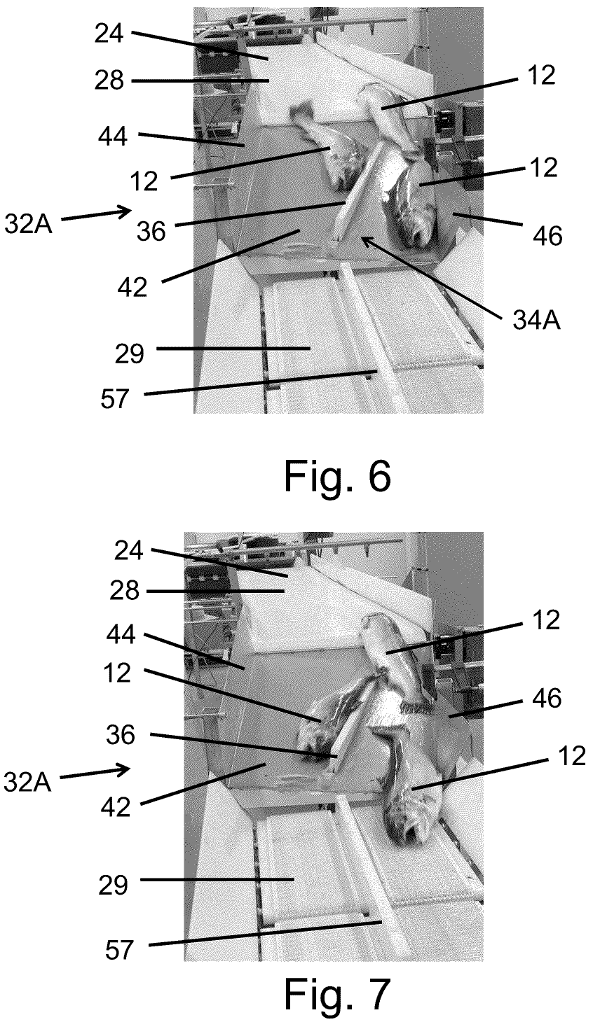

FIG. 6 shows a perspective view of the handling installation of FIGS. 3 to 5, after the deflecting device has been deployed;

FIG. 7 shows a perspective view of the handling installation of FIGS. 3 to 6 as the deflecting device deflects at least one food item of the cluster of food items;

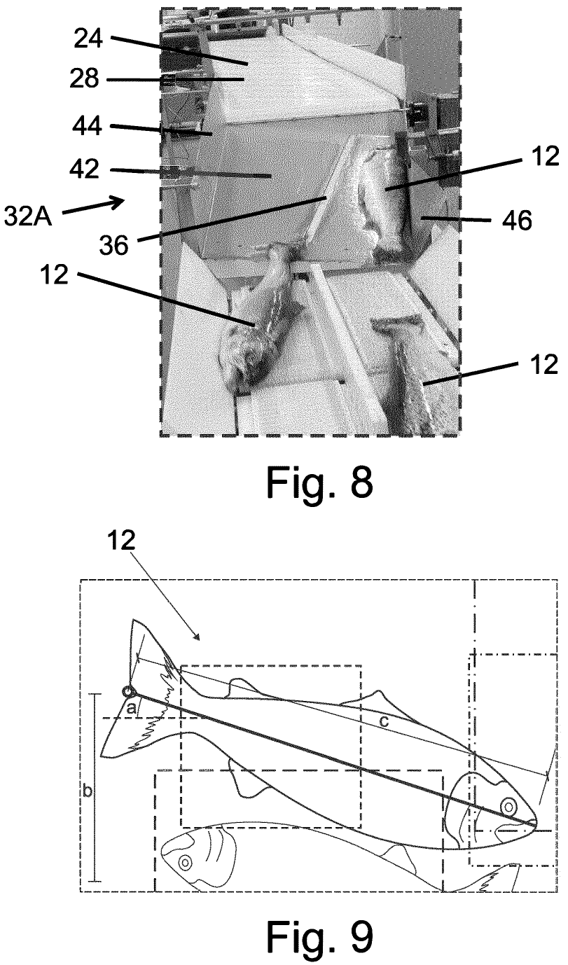

FIG. 8 shows a perspective view of the handling installation of FIGS. 3 to 7 after the cluster of food items has been dissolved by means of the separating device and the deflecting device has been retracted;

FIG. 9 shows an enlarged top view of a food item and information related to the food item which may be detected by a detecting device included in the handling installation;

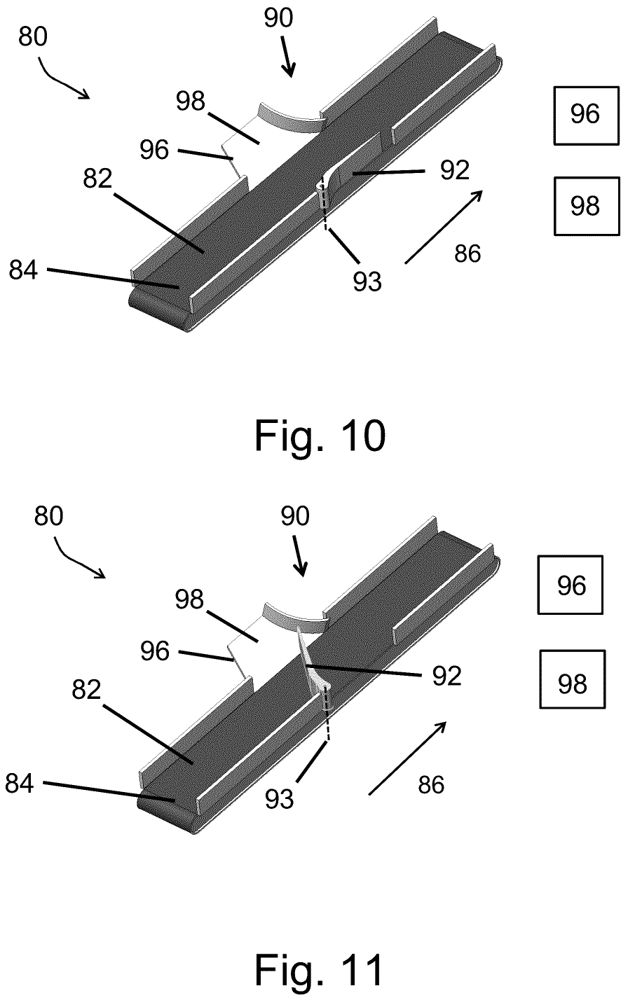

FIG. 10 shows an enlarged perspective view of a further handling installation included in the food processing installation shown in FIGS. 1 and 2 according to a further embodiment of the invention;

FIG. 11 shows an enlarged perspective view of the handling installation of FIG. 10 in which a deflecting device is deployed in a deflecting position;

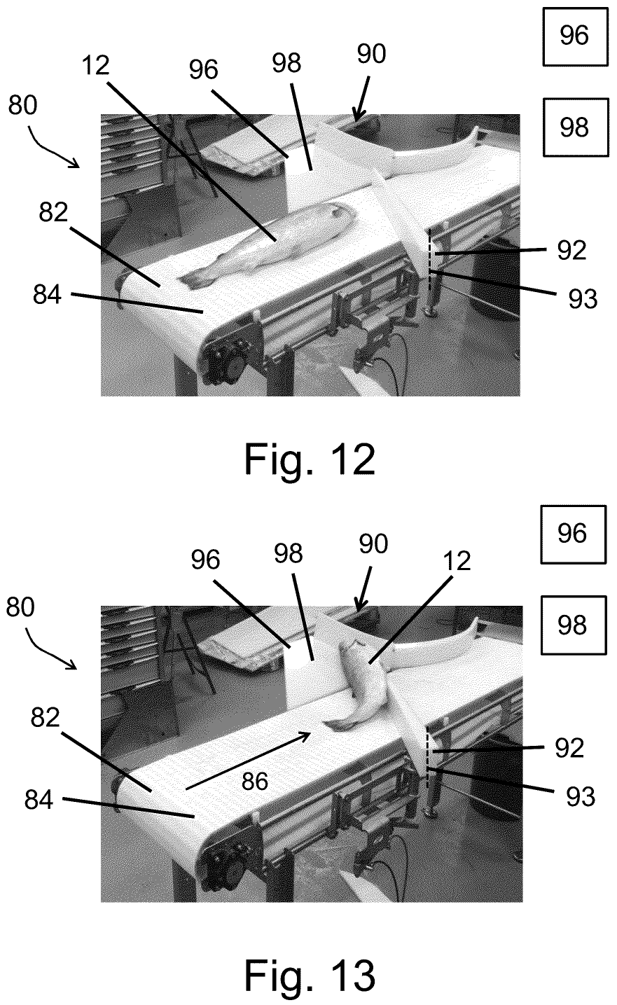

FIG. 12 shows a perspective view of the handling installation of FIGS. 10 and 11 as a food item is being conveyed on a conveying device;

FIG. 13 shows a perspective view of the handling installation of FIGS. 10 to 12 as a force is being exerted on the food item by the deflecting device to deflect the food item;

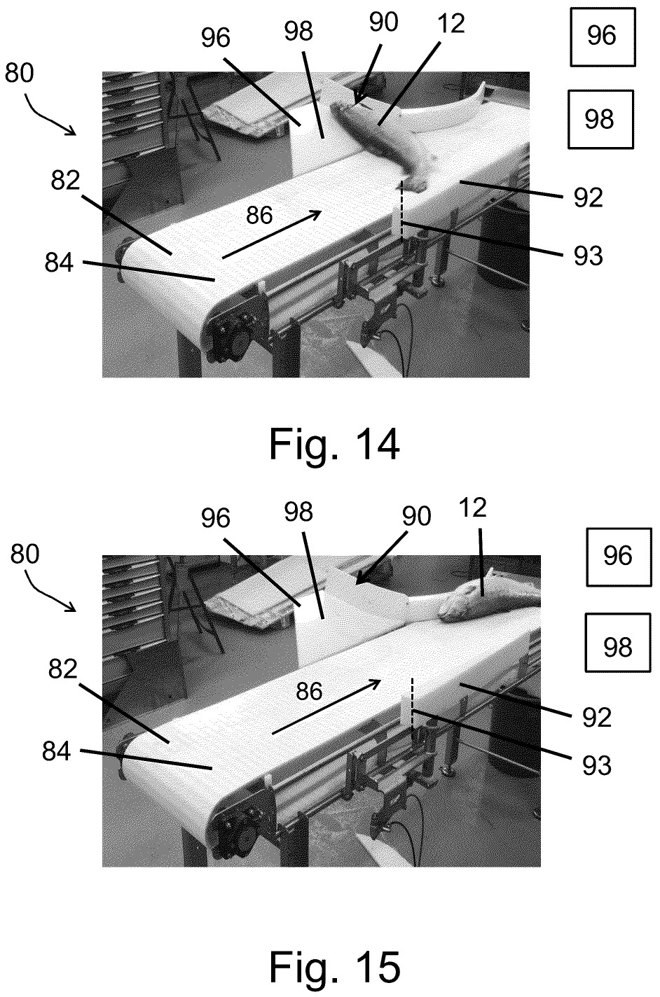

FIG. 14 shows a perspective view of the handling installation of FIGS. 10 to 13 as a force is being exerted on the food item by the deflecting device to deflect the food item;

FIG. 15 shows a perspective view of the handling installation of FIGS. 10 to 14 after the food item has been rotated.

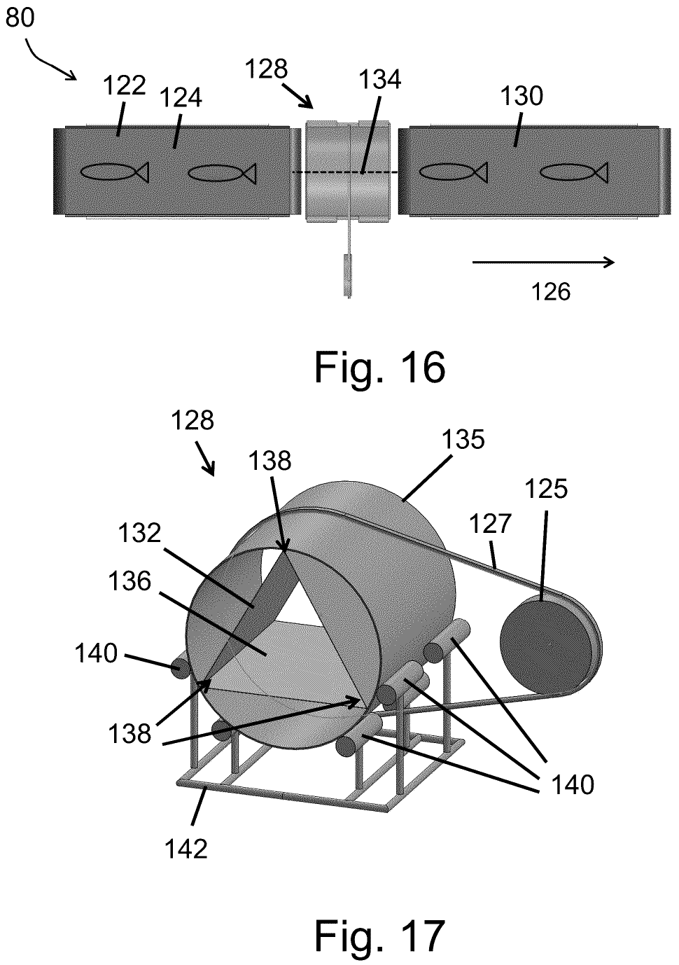

FIG. 16 shows a top view of a further handling installation included in the food processing installation shown in FIGS. 1 and 2 according to a further embodiment of the invention;

FIG. 17 shows a perspective view of the handling installation of FIG. 16;

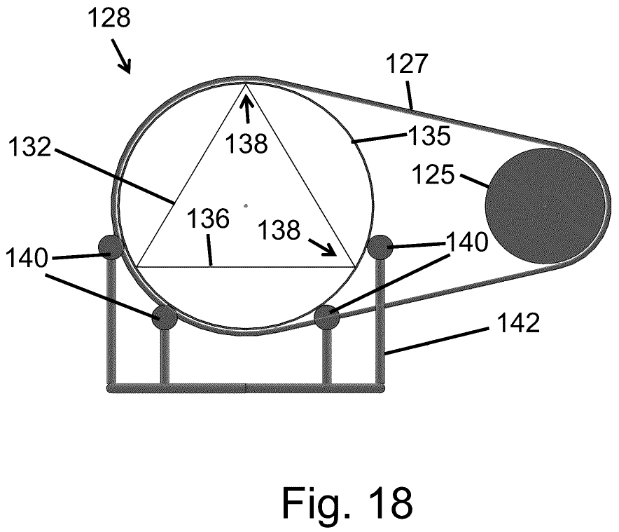

FIG. 18 shows a side view of the handling installation of FIGS. 16 and 17.

FIGS. 1 and 2 show schematic views of a food processing installation 10 for processing food items 12, preferably agricultural food items, such as fish, poultry, meat and/or plant-based food items. The food processing installation 10 may include at least one food processing station (not shown) configured to process food items 12 and at least one food handling installation configured to handle the food items 12 and feed the food items 12 to the food processing station(s). The handling installations are described further below and are shown in more detail in FIGS. 3 to 8 and 9 to 18.

The food processing station(s) may be configured to perform a variety of different processing steps, including, but not limited to, gutting, de-heading, filleting, skinning and portioning the food items. Although the Figures are depicted with fish as food items, this is merely exemplary. As detailed above, the food processing installation 10 described herein may be used to handle and/or process a wide variety of different food items.

As detailed above, the food processing installation 10 comprises at least one food handling installation configured to handle the food items 12. In the embodiment shown in FIGS. 1 and 2, the food processing installation 10 includes a first handling installation 20 for handling the food items 12. The first handling installation 20 is shown in more detail in FIGS. 3 to 8 and described below.

The handling installation 20 includes two conveying devices 22, 24, each having a support surface 26, 28 configured to support a plurality of food items 12 and configured to convey the food items 12 in the conveying direction 30. The food items 12 may be fed into the food processing installation 10, preferably in bulk, via the first conveying device 22. The food items 12 may then be transferred to the second conveying device 24 which is arranged downstream from the first conveying device 22, with respect to the conveying direction 30. The second conveying device 24 may have a greater width and/or a greater speed than the first conveying device 22, i.e., the support surface 28 may have a greater width and/or may move at a greater speed than the support surface 26. This may be advantageous to ensure that the food items 12 are arranged in a single layer on the second conveying device 24 to facilitate handling and/or processing of the food items 12.

The conveying devices 22, 24 are driven by at least one driving device (not shown) to move the respective support surfaces 26, 28 along the conveying direction 30 to convey the food items 12 in the conveying direction 30.

The handling installation 20 further includes two separating devices 32A, 32B arranged downstream from the conveying devices 22, 24, with respect to the conveying direction 30. A third conveying device 29 is arranged downstream from the first separating device 32A and upstream from the second separating device 32B. A fourth conveying device 31 is arranged downstream from the second separating device 32B. The conveying devices 29, 31 may be configured identically, or at least similarly, to the conveying devices 22, 24 and therefore will not be discussed in detail.

The separating devices 32A, 32B may be configured to at least partially separate clusters 40 of food items which are conveyed on the support surfaces 26, 28. The separation of the food clusters 40 is best seen in FIGS. 4 to 8 and is described further below.

For the sake of ease, only one separating device 32A is shown in FIGS. 3 to 8. The separating device 32B can have an identical, or at least similar, configuration. The separating device 32A has a conveying space 34A through which the food items 12 can be conveyed, preferably by means of a gravitational force. The separating device 32A further includes two deflecting devices 36, 38 which are positionable to at least partially protrude into the conveying space 34A to deflect at least one first food item 12 at least partially away from at least one second food item 12 in order to increase the spacing between at least the first food item 12 and the second food item 12 to separate the food cluster 40. The conveying space 34A is delimited at least partially by a floor 42 and two side walls 44, 46. The floor 42 may be provided with openings (not shown), such as slots, through which the deflecting devices 36, 38 may protrude and/or be deployed into the conveying space 34A. The floor 42 is declined, in the conveying direction 30 of the conveying devices 22, 24, relative to a horizontal plane, when the handling installation 20 is in an operating position, and/or relative to the support surface 26, 28 of the conveying device 22, 24. The deflecting devices 36, 38 each have a longitudinal axis 45, 47, respectively.

The deflecting devices 36, 38 are positionable to protrude through a portion of the floor 42 and into the conveying space 34A. The deflecting devices 36, 38 are movable between a non-deflecting position, in which the deflecting devices 36, 38 are retracted from the conveying space 34A, and a deflecting position, in which the deflecting devices 36, 38 protrude at least partially into the conveying space 34A to deflect the at least one first food item 12 at least partially away from the at least one second food item 12 in order to increase the spacing between at least the first food item 12 and the second food item 12 to separate a food cluster 40. As can best be seen in FIG. 3, the deflecting device 36 is positioned in the non-deflecting position and the deflecting device 38 is positioned in the deflecting position.

As can be seen schematically in FIG. 1, the longitudinal axes 45, 47 of the deflecting devices 36, 38 of the separating device 32A are angled by a first separating device angle relative to a vertical plane which extends in or along the conveying direction 30 of the conveying device 22, 24 and/or relative to a longitudinal median plane of the conveying device 22, 24 and/or a longitudinal median plane of the conveying device 22, 24 in which a longitudinal axis of the conveying device 22, 24, which preferably extends along the conveying direction 30 of the conveying device 22, 24, lies, when the handling installation 20 is in an operating position. The longitudinal axes of the deflecting devices of a second separating device 32B are angled by a second separating device angle relative to the vertical plane and/or the longitudinal median plane of the conveying device 22, 24 and/or the longitudinal median plane of the conveying device 22, 24 in which a longitudinal axis of the conveying device 22, 24, which preferably extends along the conveying direction of the conveying device 22, 24, lies, when the handling installation 20 is in an operating position. The second separating device angle is different than the first separating device angle, as can be seen schematically in FIG. 1.

The food processing installation 10 further includes a plurality of detection devices 50, 52, 54 which are configured to detect each food item 12 on the conveying devices 22, 24, 29, 31 and/or the separating devices 32A, 32B and provide information related to a location and/or an orientation of each food item 12. The deflecting devices 36, 38 may be positionable and/or a conveying speed of at least one of the conveying devices 22, 24, 29, 31 may be adjustable. For this purpose, the food processing installation 10 may include a controller 58 and optionally at least one actuator (not shown) communicatively coupled to the controller 58. The controller 58 and the actuator may be configured to perform the positioning and/or adjusting automatically based at least partially on the information provided by the detection devices 50, 52, 54. The controller 58 may be integrated in a central processing unit of the food processing installation 10. One or more of the detection devices 50, 52, 54 may be associated and/or may be communicatively coupled to the handling installation 20.

At least some, or all, of the detection devices 50, 52, 54 may be configured as an optical detection device. Such an optical detection device may be a camera, preferably a color camera, an x-ray device or any other device which can optically detect the food items 12. Alternatively, or additionally, further detection devices, such as devices which detect via contact, e.g., tactile detecting devices, or ultrasound devices may be used.

FIGS. 4 to 8 show a sequence of events as a cluster 40 of food items 12 is conveyed on the support surface 28 of the conveying device 24 towards the separating device 32A, where the cluster 40 may be separated/dissolved. At the stages shown in FIGS. 4 and 5, the deflecting device 36 of the separating device 32A is in a non-deflecting, substantially retracted, position. The deflecting device 36 is employed in FIGS. 6 and 7 as the cluster 40 reaches the deflecting device 36 by being moved into the conveying space 34A to protrude at least partially into the conveying space 34A. The deflecting device 36 may exert a force onto at least one food item 12 to deflect said food item 12 from another food item 12, thereby at least partially separating/dissolving the cluster 40, as can be seen in FIG. 8. The deflecting device 36 may then be retracted back to a non-deflecting position such that the deflecting device 36 no longer substantially protrudes into the conveying space 34A.

The conveying device 29 is provided with a separating element 57 to assist in forming multiple streams of food items 12 downstream from the separating device 32A.

FIG. 9 shows information related to a position and/or orientation of a food item 12, as the food item 12 is conveyed through the food processing installation 10, or more specifically through the handling installation 20, which may be gathered/detected, e.g., by at least one of the plurality of detection devices 50, 52, 54. The information may include at least one of the following: an angle a of the food item 12, a distance b between a point on a principal axis or longitudinal axis of the food item 12, the point being the furthest from an edge of the conveying device 22, 24, and said edge of the conveying device, a length c of the principal axis or longitudinal axis of the food item 12, and an orientation of the food item 12, e.g., an orientation of a head or a tail of a fish. The gathered/detected information may be used to position the deflecting devices 36, 38 and/or adjust a conveying speed of at least one of the conveying devices 22, 24, 29, 31.

The food processing installation 10 further includes a buffer installation 74 configured to split a single stream of food items 12, which extends substantially through the centre of the buffer installation 74, into two or more streams of food items 12 by means of a diverting device 76. The diverting device 76 may include moveable force exerting elements which are configured to exert a force onto the food items 12 to urge the food items 12 into the respective stream of food items 12. This may enable a higher throughput of food items 12 at a more consistent rate through the food processing installation 10.

The food processing installation 10 includes a further handling installation 80 for handling the food items 12 which is arranged downstream from the buffer installation 74, with respect to the conveying direction 30 of the food items. The handling installation 80 is shown in more detail in FIGS. 10 to 15. The food processing installation 10 includes a handling installation 80 on each side of the food processing installation 10. The respective handling installations 80 may be substantially identical or at least similar.

The handling installation 80 includes a conveying device 82 having a support surface 84 configured to support a plurality of food items 12. The conveying device 82 is driven by at least one driving device (not shown) to move the support surface 84 along a conveying direction to convey the food items 12 in the conveying direction 86. The conveying device 82 includes side walls 88 which at least partially delimit a conveying space of the conveying device 82.

The handling installation 80 further includes a rotating device 90 having a deflecting device 92 which is positionable between a non-deflecting position, in which the food item 12 may pass the deflecting device 92 without being deflected, as shown in FIG. 10, and a deflecting position, in which the deflecting device 92 extends along at least a section of the support surface 84, as shown in FIG. 11, to exert a force to the food item 12 as the food item 12 is conveyed on the support surface 84 and deflect the food item 12 away from the conveying direction 86 to rotate the food item 12 about an axis which is substantially perpendicular to the support surface 84 and/or about a transverse axis of the food item 12 to change an orientation of the food item 12. The deflecting device 92 is configured as an elongated arm which is mounted to be rotatable about a deflecting device rotation axis 93.

The handling installation 80 further includes a stationary platform member 96, which may be configured as a tray. The platform member 96 has a resting surface 98 which is adjacent to the support surface 84 of the conveying device 82 and configured to receive a portion of the food item 12 as the food item 12 is being deflected by the deflecting device 92. The deflecting device 92 is configured to deflect the food items 12 onto the resting surface 98 such that a portion of the food items 12 remains on the support surface 84 of the conveying device 82. A state in which a portion of the food item 12 rests on the resting surface 98 and a portion of the food item 12 remains on the support surface 84 of the conveying device 82 is best seen in FIGS. 13 and 14.

The handling installation 80 further includes at least one detection device 96 which may be configured as an optical detection device. Such an optical detection device may be a camera, preferably a color camera, an x-ray device or any other device which may be configured to optically detect the food items 12. Alternatively, or additionally, further detection devices 96, such as devices which are configured to detect via contact to an object to be detected, e.g., tactile detecting devices, or ultrasound devices may be used. The detection device 96 is configured to detect each food item 12 on the conveying device 82 and provide information related to a location and/or an orientation of the food items 12. The information provided by the detection device 96 may include at least an orientation of a pre-determined feature of the food item 12 in at least a section of the food item 12 relative to the conveying direction 86 and/or to a predetermined side of the conveying device 82.

The deflecting device 92 is positionable, preferably by means of a controller 98 and at least one actuator (not shown) communicatively coupled to the controller 98, in the non-deflecting position and/or the deflecting position based at least partially on the information provided by the detection device 96, preferably automatically by means of the controller 98 and the actuator.

Hence, by exerting a force on the food item 12 and thereby deflecting the food item 12 away from the conveying direction 86 by means of the rotating device 90, more specifically the deflecting device 92, the food item 12 may be rotated to change its orientation. In the example shown in FIGS. 12 to 15, the orientation of the fish 12, which is merely an exemplary food item 12, may thereby be changed from a head-first orientation to a tail-first orientation with respect to the conveying direction 86.

The food processing installation 10 includes a further handling installation 120 for handling the food items 12 which is arranged downstream from the handling installation 80, with respect to the conveying direction of the food items 12. The handling installation 120 is shown in more detail in FIGS. 16 to 18. The food processing installation 10 includes a handling installation 120 on each side of the food processing installation 10. The handling installations 120 may be substantially identical or at least similar.

The handling installation 120 includes a conveying device 122 having a support surface 124 configured to support a plurality of food items 12. The conveying device 122 is driven by at least one driving device (not shown) to move the support surface 124 along a conveying direction 126 to convey the food items 12 in the conveying direction 126.

The handling installation 120 further includes a rotating device 128 which is shown in more detail in FIGS. 17 and 18. A further conveying device 130 is arranged downstream, with respect to the conveying direction 126, from the rotating device 128. The rotating device 128 includes a rotatable housing 132 configured to receive therein at least one food item 12 from the conveying device 122. The housing 132 is rotatably driven by at least one drive device 125 about a housing rotation axis 134 which is parallel to or coincident with the conveying direction 126 to rotate the food item 12 about an axis which is parallel to or coincident with the housing rotation axis 134, preferably about a longitudinal axis of the food item 12, and change an orientation of the food item 12. The housing 132 is arranged in an encompassing member 135, which is configured in the embodiment shown in FIGS. 16 to 18 as a circular pipe. The housing 132 is attached to the encompassing member 135 via a connection means, e.g., by means of welding, an adhesive, a rivet or bolt connection, or other connection means.

The drive forces are transferred from the drive device 125 to the housing 132 via a drive force transmitting belt 127. The drive force transmitting belt 127 is wrapped partially around the encompassing member 135 and engages an outer surface of said encompassing member 135 to transfer the drive forces from the drive device 125 to the encompassing member 135, which is then transferred to the housing 132 via the connection between the housing 132 and the encompassing member 135. Alternative force transmitting mechanisms for transferring the drive forces from the drive device 125 to the housing 132 are possible. For instance, the drive device 125 and the housing 132 and/or the encompassing member 135 may each have a gearwheel or a rotating cylinder (not shown) which may be rotatably engages to transfer the drive forces. The drive forces may be transferred via friction and/or a form fit between the force transmitting elements, e.g., the drive force transmitting belt 127, gearwheel(s) or rotating cylinder(s).

The housing 132 has an interior surface 136 configured to receive the food item 12 thereon. The interior surface 136 includes a plurality of edges 138, each edge 138 extending substantially parallel to the housing rotation axis 134, for effecting a rotation of the food item 12 about an axis which is parallel to or coincident with the housing rotation axis 134, preferably about a longitudinal axis of the food item 12, when the food item 12 is received in the housing 132, to change an orientation of the food item 12.

The handling installation 120 further includes a plurality of rolling members 140 configured to rotate about a rolling member rotation axis to directly or indirectly support the housing 132 and to allow at least the housing 132 to rotate about the housing rotation axis 134.

The rolling members 140 are rotatably mounted on a support structure 142 which supports the housing 132. The support structure 142 may be configured to be adjustable to change a distance between the housing rotation axis 134 and a surface on which the rotating device 128 is arranged.

Hence, by rotating the food items 12 via the rotating device 128, an orientation of the food item 12 may be changed. In the example shown in FIGS. 16 to 18, the orientation of the fish 12, which is merely an exemplary food item 12, may thereby be changed by changing the direction in which the underside of the fish 12, i.e., the belly of the fish 12, faces. In the case of processing fish, it may be required or desired that the belly side of the fish be arranged in a certain, preferably predetermined, direction relative to a respective processing device of the processing station.

The food processing installation 10 further includes two further detecting devices 160, which may be configured identically, or at least similarly, to the detecting devices 50, 52, 54 described above. The detecting devices 160 may serve as a post-handling quality check, e.g., to ensure that the orientations and positions of each food item 12 is as desired and/or required. Two outlet conveyor devices 162 feed the two streams of food items 12 to downstream stations, e.g., to processing stations. Alternatively, only one stream or more than two streams of food items may be fed to downstream stations.

The handling installations 20, 80 and 120 described above may be used together, i.e., in a single food processing installation, as shown in FIGS. 1 and 2. However, alternatively, the handling installations 20, 80 and 120 may be installed independently from each other. Thus, a food processing installation may include one or more of the handling installations 20, 80 and 120 in any combination thereof.

1.-15. (canceled)

16. A handling installation for handling food items, the handling installation including:
at least one conveying device having at least one support surface configured to support a plurality of food items,
wherein the conveying device is driven by at least one driving device to move the support surface along a conveying direction to convey the food items in the conveying direction; and
at least one separating device arranged downstream from the conveying device, with respect to the conveying direction, the separating device being configured to at least partially separate clusters of food items which are conveyed on the support surface;
wherein the separating device has at least one conveying space through which the food items can be conveyed and at least one deflecting device being positionable to at least partially protrude into the conveying space to deflect at least one first food item at least partially away from at least one second food item in order to increase the spacing between at least the first food item and the second food item to separate a food cluster.

17. The handling installation according to claim 16, wherein the separating device has a floor which at least partially delimits the conveying space and along which the food items can be conveyed through the conveying space,
wherein the deflecting device is positionable to protrude through at least a portion of the floor and into the conveying space.

18. The handling installation according to claim 16, wherein the deflecting device is movable between a non-deflecting position, in which the deflecting device is retracted from the conveying space, and a deflecting position, in which the deflecting device protrudes at least partially into the conveying space to deflect the at least one first food item at least partially away from the at least one second food item in order to increase the spacing between at least the first food item and the second food item to separate a food cluster.

19. The handling installation according to claim 16, including a plurality of separating devices arranged in series, with respect to a conveying direction of the food items, each separating device having at least one conveying space through which the food items can be conveyed in a respective conveying direction and at least one deflecting device, wherein:
a longitudinal axis of at least one deflecting device of a first separating device of the plurality of separating devices is angled by a first separating device angle relative to a vertical plane which extends in or along the conveying direction of the conveying device and/or relative to a longitudinal median plane of the conveying device and/or a longitudinal median plane of the conveying device in which a longitudinal axis of the conveying device, which extends along the conveying direction of the conveying device, lies, when the handling installation is in an operating position; and
a longitudinal axis of at least one deflecting device of a second separating device of the plurality of separating devices is angled by a second separating device angle relative to the vertical plane and/or the longitudinal median plane of the conveying device and/or the longitudinal median plane of the conveying device in which a longitudinal axis of the conveying device, which extends along the conveying direction of the conveying device, lies, when the handling installation is in an operating position, the second separating device angle being different than the first separating device angle.

20. The handling installation according to claim 19, wherein:
the longitudinal axis of at least one deflecting device of the first separating device and the longitudinal axis of at least one deflecting device of the second separating device are angled towards opposite sides of the vertical plane and/or the longitudinal median plane of the conveying device and/or the longitudinal median plane of the conveying device in which a longitudinal axis of the conveying device, which extends along the conveying direction of the conveying device, lies, when the handling installation is in an operating position; and/or
the centerline of the conveying space of the first separating device and the centerline of the conveying space of the second separating device are angled towards opposite sides of the vertical plane and/or the longitudinal median plane of the conveying device and/or the longitudinal median plane of the conveying device in which a longitudinal axis of the conveying device, which extends along the conveying direction of the conveying device, lies, when the handling installation is in an operating position.

21. The handling installation according to claim 16, further including at least one detection device, an optical detection device, configured to detect each food item on the conveying device(s) and/or the separating device(s) and provide information related to a location and/or an orientation of each food item,
wherein at least one deflecting device is positionable and/or a conveying speed of at least one conveying device and/or conveying speeds of a plurality of conveying devices is/are adjustable, by means of a controller and optionally at least one actuator communicatively coupled to the controller, based at least partially on the information provided by the detection device, the controller and the actuator being configured to perform the positioning and/or adjusting automatically.

22. The handling installation according to claim 21, wherein the information provided by the detection device includes at least one of the following: an angle (a) between an axis, a longitudinal axis, of the food item and a conveying direction of the food item, a length (c) of the food item along the conveying direction of the food item, a distance (b) of the food item to a border of the conveying device(s) and/or the separating device(s), an orientation of the food item relative to the conveying direction and an orientation of a pre-determined feature of the food item in at least a section of the food item relative to the conveying direction of the food item and/or to a predetermined side of the conveying device.

23. The handling installation according to claim 16, wherein the food items are whole fish.

24. The handling installation according to claim 16, wherein the separating device is configured such that the food items can be conveyed through the at least one conveying space by means of a gravitational force.

25. The handling installation according to claim 16, wherein the separating device is configured to provide a plurality of lanes, including at least 2 lanes, in each of which food items can be conveyed, in a single file.

26. The handling installation according to claim 16, wherein the deflecting device is movable along a single degree of freedom, up-and-down, between a non-deflecting position, in which the deflecting device is retracted from the conveying space, and a deflecting position, in which the deflecting device protrudes at least partially into the conveying space to deflect the at least one first food item at least partially away from the at least one second food item in order to increase the spacing between at least the first food item and the second food item to separate a food cluster.

27. The handling installation according to claim 16, wherein the deflecting device is configured to be orientated relative to the conveying direction of the food items along the conveying device such that a longitudinal axis of the deflecting device is angled relative to the conveying direction by a non-zero degree angle, by an angle of at least 10°

28. The handling installation according to claim 16, wherein the deflecting device has a length and a height, wherein the deflecting device has a length-to-height ratio of at least 1.5.

29. The handling installation according to claim 16, wherein the deflecting device extends along a conveying direction of the food items in the conveying space by a distance of at least 8 cm.

30. A method for handling food items, including the following steps:
conveying a plurality of food items on at least one support surface of at least one conveying device, the conveying device being driven by at least one driving device to move the support surface along a conveying direction to convey the food items in the conveying direction;
feeding the plurality of food items from the support surface of the conveying device to a conveying space of a separating device arranged downstream from the conveying device, with respect to the conveying direction, the food items being conveyed through the conveying space;
at least partially separating clusters of food items which are conveyed on the support surface and/or in the conveying space by positioning at least one deflecting device of the separating device to at least partially protrude into the conveying space to deflect at least one first food item at least partially away from at least one second food item in order to increase the spacing between at least the first food item and the second food item.
